(19) United States
(12) Patent Application Publication
(10) Pub. No.: US 2023/0419231 A1
(43) Pub. Date: Dec. 28, 2023

(54) METHOD FOR ONLINE EVALUATION AND ONLINE SERVER FOR EVALUATION

(71) Applicant: VISITS Technologies, Inc., Tokyo (JP)

(72) Inventors: Masaru MATSUMOTO, Tokyo (JP); Minoru KURIYAMA, Tokyo (JP)

(21) Appl. No.: 18/211,006

(22) Filed: Jun. 16, 2023

(30) Foreign Application Priority Data
Jun. 23, 2022 (JP) 2022-101344

(51) Int. Cl. G06Q 10/0639

(52) U.S. Cl. CPC G06Q 10/06393

(57) ABSTRACT

A method for online evaluation includes analyzing, by a server, a degree of strictness of each evaluator, calculating, by the server, an evaluation ability score of each evaluator based on closeness between a provisional score of an evaluation target by all the evaluators and an evaluation of the evaluation target by each evaluator, and calculating, by the server, a final score of the evaluation target in consideration of the evaluation ability score of each evaluator.

### CROSS REFERENCE TO RELATED APPLICATIONS

The present invention claims the benefit of priority to Japanese Patent Application No. 2022-101344 filed on Jun. 23, 2022 with the Japanese Patent Office, the entire contents of which are incorporated herein by reference in its entirety.

### FIELD OF THE INVENTION

The present invention relates to a method for performing online evaluation. Further, the present invention also relates to an online server for performing evaluation.

### BACKGROUND OF THE INVENTION

There are many situations in the world where things are evaluated and some decisions are made according to the evaluation results. As familiar examples, there are cases where a business idea is evaluated, or company value is evaluated. Innovative businesses and companies with high growth potential will be promising investment destinations. In addition, there are innumerable other evaluation targets, and various evaluation targets in various fields such as politics, economy, society, industry, science, environment, and education exist. Further, within a company, there are various evaluation targets in various departments such as personnel, labor, education, accounting, legal affairs, corporate planning, technological development, security, information management, marketing and sales.

When evaluating things, it is effective to comprehensively evaluate them by a plurality of persons rather than by one person in order to enhance the objectivity of the evaluation. In addition, with the progress of Internet technology, it is possible to collect evaluations from a large number of evaluators online.

For example, Japanese Patent Application Publication No. 2014-500532 (Patent Literature 1) proposes a method wherein examinees evaluate each other's answers for a question without a model answer. It is disclosed in the literature that a system comprises a memory device resident in a computer and a processor provided in communication with the memory device, wherein the processor is configured to request a candidate to create a question based on a theme; to receive the question from the candidate; to request an evaluation of the question and the theme from at least one evaluator; and to receive a question score from each evaluator, wherein the question score is an objective measure of the evaluation of the question and the evaluator; to receive a grade for each evaluator; and to calculate a grade for the candidate based on the question score from each evaluator and the grade for each evaluator.

In WO 2017/145765 (Patent Literature 2), there is disclosed an online test method that enables simple and objective measurement of each examinee's idea creativity by determining the connoisseurship of each examinee and reflecting the result in each examinee's evaluation. Specifically, there is disclosed an online test method to evaluate an innovation ability such as the ability to create many highly evaluated ideas, the ability to create a wide range of highly evaluated ideas, or the ability to create rare and highly evaluated ideas, in which an online test is conducted in which a number of examinees are asked to select a situation setting related to 5W1H from the options and to describe their ideas as much as possible within the time limit, and the answers from the examinees are weighted according to a predetermined standard and the total score is calculated.

In WO 2020/153383 (Patent Literature 3), there is disclosed a method for collecting and evaluating problems online, comprising collecting various problems or solutions to problems from multiple examinees via a computer network and allowing the examinees to evaluate each other, and scoring the problems or the solutions to problems.

### PRIOR ART

### Patent Literature

[Patent Literature 1] Japanese Patent Application Publication No. Japanese Patent Publication No. 2014-500532
[Patent Literature 2] WO 2017/145765
[Patent Literature 3] WO 2020/153383

### SUMMARY OF THE INVENTION

In Patent Literature 1, a grade is given to an evaluator, which is determined based on evaluations by other evaluators. Therefore, in Patent Literature 1, in order to grade a candidate, it is necessary not only to evaluate the question created by the candidate but also to mutually evaluate other evaluators among the evaluators, which imposes a heavy burden on the evaluators.

In Patent Literature 2, when the examinee's ability to create ideas is mutually evaluated, weighting is given according to the examinee's connoisseurship as an evaluator, but the examinee's connoisseurship is ranked based on their ability to create ideas. Therefore, it is not necessary for the examinees to mutually evaluate their connoisseurship, and the burden on the examinees is small. However, in the online test method of Patent Literature 2, the examinees need to participate in the idea creation test, and the connoisseurship as an evaluator cannot be measured independently. In addition, the connoisseurship as an evaluator does not always match the ability to create ideas. There may be examinees who have high ability to create ideas but have low connoisseurship as evaluators, and examinees who have low ability to create ideas but have high connoisseurship as evaluators. Therefore, it is desirable that the connoisseurship as an evaluator is ranked independently of the ability to create ideas.

In Patent Literature 3, when scoring a problem or a solution to the problem, weighting is given to evaluation from examinees with high connoisseurship. However, it is based on the assumption that examinees who are highly evaluated for problem creation or solution creation also have high connoisseurship. Therefore, there is a problem similar to that of Patent Literature 2.

The present invention has been created in view of the above circumstances, and in one embodiment, it is an object to provide a method for online evaluation that can independently calculate the evaluation of an evaluation target such as an idea, and the connoisseurship (evaluation ability) of evaluators who evaluate the evaluation target without imposing a heavy burden on the evaluators. Further, in another embodiment, an object of the present invention is to provide a server for carrying out such an evaluation method online.

As a result of diligent studies to solve the above problems, the present inventors have found the following online evaluation method and server contribute to problem solving, the method comprising analyzing, by a server, a degree of strictness of each evaluator, then calculating, by the server, an evaluation ability score of each evaluator based on closeness between a provisional score of an evaluation target by all the evaluators and an evaluation of the evaluation target by each evaluator, and calculating, by the server, a final score of the evaluation target in consideration of the evaluation ability score of each evaluator.

[1] A method for online evaluation, comprising:
a step 1A in which a server allocates evaluators who should evaluate a plurality of evaluation targets that are stored in an evaluation target data storage part and are assigned identifiers, from among a plurality of evaluators who are assigned identifiers as evaluators of a current evaluation session;
a step 1B in which the server extracts data related to the plurality of evaluation targets from the evaluation target data storage part according to a result of the step 1A, extracts question data related to a predetermined theme from a question data storage part, extracts first format data for evaluation input including a selective evaluation input section based on at least one evaluation axis from a first format data storage part, and transmits the data related to the plurality of evaluation targets, the question data, and the first format data to corresponding terminals of the plurality of evaluators via a network;
a step 1C in which the server receives evaluation result data including evaluations of the evaluation targets input by each evaluator in the selective evaluation input section, from the terminal of each evaluator via the network;
a step 1 D in which the server assigns an identifier to each of the evaluation result data that have been received, and stores the evaluation result data in an evaluation result data storage part in association with the identifier of each evaluator who has transmitted the evaluation result data and the identifier of each evaluation target;
a step 1E in which the server analyzes a degree of strictness of the evaluation by each evaluator for each evaluation axis based on the evaluation input in the selective evaluation input section by each evaluator in the evaluation result data stored in the evaluation result data storage part, and calculates a corrected evaluation by correcting the evaluation such that the evaluation by the evaluator who gives a strict evaluation rises relatively and the evaluation by the evaluator who gives a lax evaluation decreases relatively, and stores the corrected evaluation in the evaluation result data storage part in association with the identifier of each evaluator and the identifier of each evaluation target;
a step 1F in which the server aggregates the evaluations of each evaluation target based on the corrected evaluation and the identifier of the evaluation target stored in the evaluation result data storage part to calculate a provisional score of each evaluation target for each evaluation axis, and stores the provisional score in an evaluation target score data storage part in association with the identifier of each evaluation target;
a step 1G in which the server compares for each evaluation axis the corrected evaluation of each evaluation target associated with the identifier of the evaluator stored in the evaluation result data storage part with the provisional score of each evaluation target stored in the evaluation target score data storage part, aggregates closeness between them for each evaluator to calculate an evaluation ability score of each evaluator, and stores the evaluation ability score in an evaluator score data storage part in association with the identifier of each evaluator;
a step 1H in which the server aggregates the evaluations of each evaluation target based on the corrected evaluation, the identifier of the evaluators and the identifier of the evaluation target stored in the evaluation result data storage part, and the evaluation ability score of each evaluator stored in the evaluator score data storage part, to calculate a corrected score of each evaluation target for each evaluation axis on condition that a greater weighting is given to the evaluation by the evaluator with a higher evaluation ability score, and the server stores the corrected score in the evaluation target score data storage part in association with the identifier of each evaluation target; and
a step 1I in which the server extracts either or both of the following data (1) and (2), and transmits them to a terminal of an administrator via the network:
(1) data related to the evaluation targets, including the corrected score itself of each evaluation target for each evaluation axis and/or a statistic calculated based on the corrected score, stored in the evaluation target score data storage part.
(2) data related to the evaluators, including the evaluation ability score itself of each evaluator and/or a statistic calculated based on the evaluation ability score, stored in the evaluator score data storage part.

[2] The method for online evaluation according to [1], wherein the corrected score of each evaluation target is regarded as the provisional score, and the server repeats the step 1G and the step 1 H one or more times.

[3] The method for online evaluation according to [2], wherein the server stops repeating the step 1G any more when either or both of the following conditions (a) and (b) are satisfied:
(a) each time the step 1G is repeated, the server calculates a difference or rate of change for each evaluation axis between a latest evaluation ability score and a previous evaluation ability score of each evaluator, and when the server judges whether or not the difference or rate of change satisfies a preset condition for each evaluator, the preset condition is satisfied for all the evaluators;
(b) each time the step 1 H is repeated, the server calculates a difference or rate of change for each evaluation axis between a latest corrected score and a previous corrected score of each evaluation target, and when the server judges whether or not the difference or rate of change satisfies a preset condition for each evaluation target, the preset condition is satisfied for all the evaluation targets.

[4] A method for online evaluation, comprising:
a step 1A in which a server allocates evaluators who should evaluate a plurality of evaluation targets that are stored in an evaluation target data storage part and are assigned identifiers, from among a plurality of evaluators who are assigned identifiers as evaluators for a current evaluation session;
a step 1B in which the server extracts data related to the plurality of evaluation targets from the evaluation target data storage part according to a result of the step 1A, extracts question data related to a predetermined theme from a question data storage part, and extracts first format data for evaluation input including a selective evaluation input section based on at least one evaluation axis from a first format data storage part, and transmits the data related to the plurality of evaluation targets, the question data, and the first format data to corresponding terminals of the plurality of evaluators via a network;
a step 1C in which the server receives evaluation result data including evaluations of the evaluation targets input by each evaluator in the selective evaluation input section, from the terminal of each evaluator via the network;
a step 1 D in which the server assigns an identifier to each of the evaluation result data that have been received, and stores the evaluation result data in an evaluation result data storage part in association with the identifier of each evaluator who has transmitted the evaluation result data and the identifier of each evaluation target;
a step 1E in which the server analyzes a degree of strictness of the evaluation by each evaluator for each evaluation axis based on the evaluation input in the selective evaluation input section by each evaluator in the evaluation result data stored in the evaluation result data storage part, and calculates a corrected evaluation by correcting the evaluation such that the evaluation by the evaluator who gives a strict evaluation rises relatively and the evaluation by the evaluator who gives a lax evaluation decreases relatively, and stores the corrected evaluation in the evaluation result data storage part in association with the identifier of each evaluator and the identifier of each evaluation target;
a step 1F in which, the server performs for each of the first to n^{th} evaluator, assuming that a number of the evaluators is n (n is an integer of 2 or more), without considering the evaluation of the evaluation target by the k^{th} evaluator (k is an integer from 1 to n), aggregating the evaluations of each evaluation target based on the corrected evaluation by the evaluators other than the k^{th} evaluator and the identifier of the evaluation target stored in the evaluation result data storage part to calculate a provisional score of each evaluation target for each evaluation axis, and storing the provisional score in an evaluation target score data storage part in association with the identifier of the k^{th} evaluator and the identifier of each evaluation target;
a step 1G₁ in which the server performs for each of the first to n^{th} evaluator comparing for each evaluation axis the corrected evaluation of each evaluation target associated with the identifier of the k^{th} (k is an integer from 1 to n) evaluator stored in the evaluation result data storage part with the provisional score of each evaluation target stored in the evaluation target score data storage part associated with the identifier of the k^{th} evaluator and the identifier of each evaluation target, aggregating closeness between them for each evaluator to calculate a provisional evaluation ability score of the k^{th} evaluator, and storing the provisional evaluation ability score in the evaluator score data storage part in association with the identifier of the k^{th} evaluator;
a step 1H₁ in which the server performs for each of the first to n^{th} evaluator, without considering the evaluation of the evaluation target by the k^{th} evaluator (k is an integer from 1 to n), aggregating the evaluations of each evaluation target based on the corrected evaluation by the evaluators other than the k^{th} evaluator, the identifier of the evaluators and the identifier of the evaluation target stored in the evaluation result data storage part, and the provisional evaluation ability score of the evaluators other than the k^{th} evaluator stored in the evaluator score data storage part to calculate a corrected score of each evaluation target for each evaluation axis, on condition that a greater weighting is given to the evaluation by the evaluator with a higher provisional evaluation ability score, and storing the corrected score in the evaluation target score data storage part in association with the identifier of the k^{th} evaluator and the identifier of each evaluation target;
a step 1G₂ in which the server performs for each of the first to n^{th} evaluator comparing for each evaluation axis the corrected evaluation of each evaluation target associated with the identifier of the k^{th} (k is an integer from 1 to n) evaluator stored in the evaluation result data storage part with the corrected score of each evaluation target stored in the evaluation target score data storage part associated with the identifier of the k^{th} evaluator and the identifier of each evaluation target, aggregating closeness between them for each evaluator to calculate a final evaluation ability score of the k^{th} evaluator, and storing the final evaluation ability score in the evaluator score data storage part in association with the identifier of the k^{th} evaluator;
a step 1 H₂ in which the server aggregates the evaluations of each evaluation target based on the corrected evaluation, the identifier of the evaluators and the identifier of the evaluation target stored in the evaluation result data storage part, and the final evaluation ability score of each evaluator stored in the evaluator score data storage part, to calculate a final score of each evaluation target for each evaluation axis, on condition that a greater weighting is given to the evaluation by the evaluator with a higher final evaluation ability score, and the server stores the final score in the evaluation target score data storage part in association with the identifier of each evaluation target; and
a step 1I in which the server extracts either or both of the following data (1) and (2) and transmits them to a terminal of an administrator via the network:
(1) data related to the evaluation targets, including the final score itself of each evaluation target for each evaluation axis and/or a statistic calculated based on the final score, stored in the evaluation target score data storage part.
(2) data related to the evaluators, including the final evaluation ability score itself of each evaluator and/or a statistic calculated based on the final evaluation ability score, stored in the evaluator score data storage part.

[5] The method for online evaluation according to [4], wherein the corrected score of each evaluation target is regarded as the provisional score, and the server repeats the step 1G₁ and the step 1H₁ one or more times.

[6] The method for online evaluation according to [5], wherein the server stops repeating the step 1G₁ any more when either or both of the following conditions (a) and (b) are satisfied:
(a) each time the step 1G₁ is repeated, the server calculates a difference or rate of change for each evaluation axis between a latest provisional evaluation ability score and a previous provisional evaluation ability score of each evaluator, and when the server judges whether or not the difference or rate of change satisfies a preset condition for each evaluator, the preset condition is satisfied for all the evaluators;
(b) each time the step 1H₁ is repeated, the server calculates a difference or rate of change for each evaluation axis between a latest corrected score and a previous corrected score of each evaluation target, and when the server judges whether or not the difference or rate of change satisfies a preset condition for each evaluation target, the preset condition is satisfied for all the evaluation targets.

[7] The method for online evaluation according to any one of [1] to [6], wherein the evaluation target data storage part may also store data related to a plurality of different evaluation targets from the plurality of evaluation targets used in the current evaluation session, and the method further comprises:
a step 1J in which the server calculates similarity between each of the plurality of evaluation targets in the current evaluation session and the other evaluation targets used in the current evaluation session and/or the different evaluation targets, aggregates the similarity to calculate a rarity score of each evaluation target in the current evaluation session, and stores the rarity score in the evaluation target score data storage part in association with the identifier each evaluation target; and
a step 1K in which the server transmits data related to the evaluation targets, including the rarity score itself of each evaluation target and/or a statistic calculated based on the rarity score, stored in the evaluation target score data storage part, to the terminal of the administrator via the network.

[8] The method for online evaluation according to any one of [1] to [7], further comprising:
a step 2A in which the server extracts the question data related to the predetermined theme from the question data storage part, extracts a second format data including at least one information input section from a second format data storage part, and transmits the question data and the second format data via the network to terminals of a plurality of answerers who are assigned identifiers as answerers of a collection session;
a step 2B in which the server receives answer data including information about the theme input by each answerer of the collection session in the information input section from the terminal of each answerer of the collection session; and
a step 2C in which the server assigns an identifier to each of the answerer data that have been received including the information about the theme, and stores the answer data including the information about the theme in the evaluation target data storage part in association with the identifier of each answerer in the collection session who has transmitted the answer data including the information about the theme;
wherein the answer data including the information about the theme is used as the data related to the evaluation targets.

[9] The method for online evaluation according to [8], further comprising:
a step 2D in which the server calculates a score of the answerer for at least one evaluation axis, based on data related to the evaluation targets including the corrected score or the final score itself of each evaluation target for each evaluation axis and/or a statistic calculated based on the corrected score or the final score, and the identifier of the answerer stored in the evaluation target score data storage part, and the server stores the score of the answerer in a answerer score data storage part; and
a step 2E in which the server transmits data related to the answerers, including the score itself of each answerer for each evaluation axis and/or a statistic calculated based on the score stored in the answerer score data storage part, to the terminal of the administrator via the network.

[10] The method for online evaluation according to any one of [1] to [9], wherein the evaluation targets are ideas related to the predetermined theme.

[11] The method for online evaluation according to any one of [1] to [10], wherein the data related to the evaluation targets include text information.

[12] A server for online evaluation, comprising a transceiver, a control unit, and a storage unit, wherein
the storage unit comprises:
   an evaluation target data storage part for storing data related to a plurality of evaluation targets,
   a first format data storage part for storing first format data for evaluation input including a selective evaluation input section based on at least one evaluation axis;
   an evaluation result data storage part for storing evaluation result data including an evaluation and a corrected evaluation of each evaluation target;
   an evaluation target score data storage part for storing a provisional score and a corrected score of each evaluation target for each evaluation axis;
   an evaluator score data storage part for storing an evaluation ability score of each evaluator;
the control unit comprises an evaluator allocation part, an evaluation input data extraction part, a data registration part, an evaluation analysis part, and an evaluation analysis data extraction part, wherein
   the evaluator allocation part is capable of performing a step 1A comprising allocating evaluators who should evaluate the plurality of evaluation targets that are stored in the evaluation target data storage part and are assigned identifiers, from among a plurality of evaluators who are assigned identifiers as evaluators of a current evaluation session, the evaluation input data extraction part is capable of performing a step 1B comprising extracting the data related to the plurality of evaluation targets from the evaluation target data storage part according to a result of the step 1A, extracting question data related to a predetermined theme from a question data storage part, extracting the first format data from the first format data storage part, and transmitting the data related to the plurality of evaluation targets, the question data, and the first format data to corresponding terminals of the plurality of evaluators via a network;
the transceiver is capable of performing a step 1C comprising receiving the evaluation result data including evaluations of the evaluation targets input by each evaluator in the selective evaluation input section, from the terminal of each evaluator via the network, wherein
   the data registration part is capable of performing a step 1D comprising assigning an identifier to each of the evaluation result data that have been received, and storing the evaluation result data in the evaluation result data storage part in association with the identifier of each evaluator who has transmitted the evaluation result data and the identifier of each evaluation target;
   the evaluation analysis part is:
      capable of performing a step 1 E comprising analyzing a degree of strictness of the evaluation of each evaluator for each evaluation axis based on the evaluation input in the selective evaluation input section by each evaluator in the evaluation result data stored in the evaluation result data storage part, and calculating a corrected evaluation by correcting the evaluation such that the evaluation by the evaluator who gives a strict evaluation rises relatively and the evaluation by the evaluator who gives a lax evaluation decreases relatively, and storing the corrected evaluation in the evaluation result data storage part in association with the identifier of each evaluator and the identifier of each evaluation target;
      capable of performing a step 1F comprising aggregating the evaluations of each evaluation target based on the corrected evaluation and the identifier of the evaluation target stored in the evaluation result data storage part to calculate the provisional score of each evaluation target for each evaluation axis, and storing the provisional score in the evaluation target score data storage part in association with the identifier of each evaluation target;
      capable of performing a step 1G comprising comparing for each evaluation axis the corrected evaluation of each evaluation target associated with the identifier of the evaluator stored in the evaluation result data storage part with the provisional score of each evaluation target stored in the evaluation target score data storage part, aggregating closeness between them for each evaluator to calculate the evaluation ability score of each evaluator, and storing the evaluation ability score in the evaluator score data storage part in association with the identifier of each evaluator;
      capable of performing a step 1H comprising aggregating the evaluations for each evaluation target based on the corrected evaluation, the identifier of the evaluators and the identifier of the evaluation target stored in the evaluation result data storage part, and the evaluation ability score of each evaluator stored in the evaluator score data storage part, to calculate the corrected score of each evaluation target for each evaluation axis, on condition that a greater weighting is given to the evaluation by the evaluator with a higher evaluation ability score, and storing the corrected score in the evaluation target score data storage part in association with the identifier of each evaluation target; and
      the evaluation analysis data extraction part is capable of perform a step 1I comprising extracting either or both of the following data (1) and (2), and transmitting them from the transceiver to a terminal of an administrator via the network:
   (1) data related to the evaluation targets, including the corrected score itself of each evaluation target for each evaluation axis and/or a statistic calculated based on the corrected score, stored in the evaluation target score data storage part.
   (2) data related to the evaluators, including the evaluation ability score itself of each evaluator and/or a statistic calculated based on the evaluation ability score, stored in the evaluator score data storage part.

[13] The server for online evaluation according to [12], wherein the corrected score of each evaluation target is regarded as the provisional score, and the evaluation analysis part is capable of repeating the step 1G and the step 1H one or more times.

[14] The server for online evaluation according to [13], wherein the evaluation analysis part stops repeating the step 1G any more when either or both of the following conditions (a) and (b) are satisfied:
(a) each time the step 1G is repeated, the evaluation analysis part calculates a difference or rate of change for each evaluation axis between a latest evaluation ability score and a previous evaluation ability score of each evaluator, and when the evaluation analysis part judges whether or not the difference or rate of change satisfies a preset condition for each evaluator, the preset condition is satisfied for all the evaluators;
(b) each time the step 1 H is repeated, the evaluation analysis part calculates a difference or rate of change for each evaluation axis between a latest corrected score and a previous corrected score of each evaluation target, and when the evaluation analysis part judges whether or not the difference or rate of change satisfies a preset condition for each evaluation target, the preset condition is satisfied for all the evaluation targets.

[15] A server for online evaluation, comprising a transceiver, a control unit, and a storage unit, wherein
the storage unit comprises:
   an evaluation target data storage part for storing data related to a plurality of evaluation targets,
   a first format data storage part for storing first format data for evaluation input including a selective evaluation input section based on at least one evaluation axis;
   an evaluation result data storage part for storing evaluation result data including an evaluation and a corrected evaluation of each evaluation target;
   an evaluation target score data storage part for storing a provisional score, a corrected score, and a final score of each evaluation target for each evaluation axis;
   an evaluator score data storage part for storing a provisional evaluation ability score and a final evaluation ability score of each evaluator;
the control unit comprises an evaluator allocation part, an evaluation input data extraction part, a data registration part, an evaluation analysis part, and an evaluation analysis data extraction part, wherein
   the evaluator allocation part is capable of performing a step 1A comprising allocating evaluators who should evaluate the plurality of evaluation targets that are stored in the evaluation target data storage part and assigned identifiers, from among a plurality of evaluators who are assigned identifiers as evaluators of a current evaluation session,
   the evaluation input data extraction part is capable of performing a step 1B comprising extracting the data related to the plurality of evaluation targets from the evaluation target data storage part according to a result of the step 1A, extracting question data related to a predetermined theme from a question data storage part, extracting the first format data from the first format data storage part, and transmitting the data related to the plurality of evaluation targets, the question data, and the first format data to corresponding terminals of the plurality of evaluators via a network;
the transceiver is capable of performing a step 1C comprising receiving the evaluation result data including the evaluations of the evaluation targets input by each evaluator in the selective evaluation input section, from the terminal of each evaluator via the network, wherein
   the data registration part is capable of performing a step 1D comprising assigning an identifier to each of the evaluation result data that have been received, and storing the evaluation result data in the evaluation result data storage part in association with the identifier of each evaluator who has transmitted the evaluation result data and the identifier of each evaluation target;
   the evaluation analysis part is:
      capable of performing a step 1 E comprising analyzing a degree of strictness of the evaluation of each evaluator for each evaluation axis based on the evaluation input in the selective evaluation input section by each evaluator in the evaluation result data stored in the evaluation result data storage part, and calculating a corrected evaluation by correcting the evaluation such that the evaluation by the evaluator who gives a strict evaluation rises relatively and the evaluation by the evaluator who gives a lax evaluation decreases relatively, and storing the corrected evaluation in the evaluation result data storage part in association with the identifier of each evaluator and the identifier of each evaluation target;
      capable of performing a step 1F comprising, for each of the first to n^{th} evaluator, assuming that a number of the evaluators is n (n is an integer of 2 or more), without considering the evaluation of the evaluation target by the k^{th} evaluator (k is an integer from 1 to n), aggregating the evaluations of each evaluation target based on the corrected evaluation by the evaluators other than the k^{th} evaluator and the identifier of the evaluation target stored in the evaluation result data storage part to calculate a provisional score of each evaluation target for each evaluation axis, and storing the provisional score in the evaluation target score data storage part in association with the identifier of the k^{th} evaluator and the identifier of each evaluation target;
      capable of performing a step 1G₁ comprising, for each of the first to n^{th} evaluator, comparing for each evaluation axis the corrected evaluation of each evaluation target associated with the identifier of the k^{th} (k is an integer from 1 to n) evaluator stored in the evaluation result data storage part with the provisional score of each evaluation target stored in the evaluation target score data storage part associated with the identifier of the k^{th} evaluator and the identifier of each evaluation target, aggregating closeness between them for each evaluator to calculate the provisional evaluation ability score of the k^{th} evaluator, and storing the provisional evaluation ability score in the evaluator score data storage part in association with the identifier of the k^{th} evaluator;
      capable of performing a step 1H₁ comprising, for each of the first to n^{th} evaluator, without considering the evaluation of the evaluation target by the k^{th} evaluator (k is an integer from 1 to n), aggregating the evaluations of each evaluation target based on the corrected evaluation by the evaluators other than the k^{th} evaluator, the identifier of the evaluators and the identifier of the evaluation target stored in the evaluation result data storage part, and the provisional evaluation ability score of the evaluators other than the k^{th} evaluator stored in the evaluator score data storage part to calculate a corrected score of each evaluation target for each evaluation axis, on condition that a greater weighting is given to the evaluation by the evaluator with a higher provisional evaluation ability score, and storing the corrected score in the evaluation target score data storage part in association with the identifier of the k^{th} evaluator and the identifier of each evaluation target;
      capable of performing a step 1G₂ comprising, for each of the first to n^{th} evaluator, comparing for each evaluation axis the corrected evaluation of each evaluation target associated with the identifier of the k^{th} (k is an integer from 1 to n) evaluator stored in the evaluation result data storage part with the corrected score of each evaluation target stored in the evaluation target score data storage part associated with the identifier of the k^{th} evaluator and the identifier of each evaluation target, aggregating closeness between them for each evaluator to calculate a final evaluation ability score of the k^{th} evaluator, and storing the final evaluation ability score in the evaluator score data storage part in association with the identifier of the k^{th} evaluator;
      capable of performing a step 1H₂ comprising aggregating the evaluations of each evaluation target based on the corrected evaluation, the identifier of the evaluator and the identifier of the evaluation target stored in the evaluation result data storage part, and the final evaluation ability score of each evaluator stored in the evaluator score data storage part, to calculate the final score of each evaluation target for each evaluation axis, on condition that a greater weighting is given to the evaluation by the evaluator with a higher final evaluation ability score, and storing the final score in the evaluation target score data storage part in association with the identifier of each evaluation target; and
   the evaluation analysis data extraction part is capable of performing a step 1I comprising extracting either or both of the following data (1) and (2) and transmitting them from the transceiver to a terminal of an administrator via the network:
(1) data related to the evaluation targets, including the final score itself of each evaluation target for each evaluation axis and/or a statistic calculated based on the final score, stored in the evaluation target score data storage part.
(2) data related to the evaluators, including the final evaluation ability score itself of each evaluator and/or a statistic calculated based on the final evaluation ability score, stored in the evaluator score data storage part.

[16] The server for online evaluation according to [15], wherein the evaluation analysis part regards the corrected score of each evaluation target as the provisional score, and repeats the step 1G₁ and the step 1 H₁ one or more times.

[17] The server for online evaluation according to [16], wherein the evaluation analysis part stops repeating the step 1G₁ any more when either or both of the following conditions (a) and (b) are satisfied:
(a) each time the step 1G₁ is repeated, the evaluation analysis part calculates a difference or rate of change for each evaluation axis between a latest provisional evaluation ability score and a previous provisional evaluation ability score of each evaluator, and when the evaluation analysis part judges whether or not the difference or rate of change satisfies a preset condition for each evaluator, the preset condition is satisfied for all the evaluators;
(b) each time the step 1H₁ is repeated, the evaluation analysis part calculates a difference or rate of change for each evaluation axis between a latest corrected score and a previous corrected score of each evaluation target, and when the evaluation analysis part judges whether or not the difference or rate of change satisfies a preset condition for each evaluation target, the preset condition is satisfied for all the evaluation targets.

[18] The server for online evaluation according to any one of [12] to [17], wherein the evaluation target data storage part may also store data related to a plurality of different evaluation targets from the plurality of evaluation targets used in the current evaluation session,
the evaluation analysis part is capable of performing a step 1J comprising calculating similarity between each of the plurality of evaluation targets in the current evaluation session and the other evaluation targets used in the current evaluation session and/or the different evaluation targets, aggregating the similarity to calculate a rarity score of each evaluation target in the current evaluation session, and storing the rarity score in the evaluation target score data storage part in association with the identifier each evaluation target; and
the evaluation analysis data extraction part is capable of performing a step 1K comprising extracting data related to the evaluation targets, including the rarity score itself of each evaluation target and/or a statistic calculated based on the rarity score, stored in the evaluation target score data storage part, and transmitting them from the transceiver to the terminal of the administrator via the network.

[19] The server for online evaluation according to any one of [12] to [18], wherein
the storage unit comprises a question data storage part for storing question data related to the predetermined theme, and a second format data storage part for storing second format data including at least one information input section;
the control unit comprises an information input data extraction part;
the information input data extraction part is capable of performing a step 2A comprising extracting the question data related to the predetermined theme from the question data storage part, extracting the second format data from the second format data storage part, and transmitting the question data and the second format data from the transceiver via the network to terminals of a plurality of answerers who are assigned identifiers as answerers of a collection session;
the transceiver is capable of performing a step 2B comprising receiving answer data including information about the theme input by each answerer of the collection session in the information input section from the terminal of each answerer of the collection session; and
the data registration part is capable of performing a step 2C comprising assigning an identifier to each of the answer data that have been received including the information about the theme, and storing the answer data including the information about the theme in the evaluation target data storage part in association with the identifier of each answerer in the collection session who has transmitted the answer data including the information about the theme.

[20] The server for online evaluation according to [19], wherein
the storage unit comprises an answerer score data storage part for storing scores for each evaluation axis of the answerers;
the evaluation analysis part is capable of performing a step 2D comprising calculating a score of the answerer for at least one evaluation axis, based on data related to the evaluation targets including the corrected score or the final score itself of each evaluation target for each evaluation axis and/or a statistic calculated based on the corrected score or the final score, and the identifier of the answerer stored in the evaluation target score data storage part, and storing the score of the answerer in the answerer score data storage part; and
the evaluation analysis data extraction part is capable of performing a step 2E comprising transmitting data related to the answerers, including the score itself of each answerer for each evaluation axis and/or a statistic calculated based on the score stored in the answerer score data storage part, from the transceiver to the terminal of the administrator via the network.

[21] The server for online evaluation according to any one of [12] to [20], wherein the evaluation targets are ideas related to the predetermined theme.

[22] The server for online evaluation according to any one of [12] to [21], wherein the data related to the evaluation targets include text information.

[23] A program for causing a computer to execute the evaluation method according to any one of [1] to [11].

[24] A computer-readable recording medium on which the program according to [23] is recorded.

According to one embodiment of the present invention, it is possible to provide a method for online evaluation that can independently calculate the evaluation of an evaluation target such as an idea, and the connoisseurship (evaluation ability) of evaluators who evaluate the evaluation target without imposing a heavy burden on the evaluators. Further, according to one embodiment of the present invention, it is possible to provide a server for carrying out such an evaluation method online.

According to one embodiment of the present invention, the evaluation ability for each evaluator can be calculated based only on the evaluation given by each evaluator to the evaluation target. As a result, it is expected that the calculation result of the evaluation ability of each evaluator can be obtained with high reliability. Further, since the reliability of the calculation result of the evaluation ability of each evaluator is high, it is expected that the evaluation of the evaluation target calculated based on this is also highly reliable.

According to one embodiment of the present invention, the degree of strictness of the evaluation of the evaluation target by each evaluator is analyzed, and the evaluation is corrected such that the evaluation by the evaluator who gives a strict evaluation rises relatively and the evaluation by the evaluator who gives a lax evaluation decreases relatively. As a result, the degree of strictness of evaluation, which may differ for each evaluator, is adjusted, so that it is possible to reduce the influence of the evaluators who gives excessive evaluation.

According to one embodiment of the present invention, the evaluation of an evaluation target is performed after being weighted according to the evaluation ability of each evaluator. Therefore, even if an ineligible evaluator is mixed in the evaluator, it is possible to perform a highly accurate evaluation of the evaluation target while minimizing the influence of such evaluator.

### BRIEF DESCRIPTION OF THE DRAWINGS

FIG. 1 shows an example of the overall configuration of an online evaluation system according to an embodiment of the present invention.

FIG. 2 shows a basic hardware configuration example of a server, a participant (evaluator, answerer) terminal, a project administrator terminal, and a server administrator terminal.

FIG. 3 shows an example of a functional block diagram of a server.

FIG. 4 is an example of one table in which account information of one participant included in a participant account file is stored.

FIG. 5 is an example of one table in which session participation information of one participant included in a session participant registration data file is stored.

FIG. 6 is an example of one table in which information regarding project implementation conditions included in a project data file is stored.

FIG. 7 is an example of one table in which information about one evaluation axis included in an evaluation axis data file is stored.

FIG. 8 is an example of one table in which information about a question included in a question data file is stored.

FIG. 9 is an example of one table in which information about one answer column included in an answer column data file (summarized) is stored.

FIG. 10 is an example of one table in which information regarding detailed conditions for one answer column included in an answer column data file (detailed) is stored.

FIG. 11 is an example of a login screen displayed on an evaluator terminal.

FIG. 12 is an example of one table included in an answer data file (summarized).

FIG. 13 is an example of one table in which information regarding the specific contents of one answer data included in the answer data file (detailed) is stored.

FIG. 14 is an example of one table included in the evaluation result data file.

FIG. 15 is an example of one table included in an evaluator score data file.

FIG. 16 is an example of one table included in the answer score data file.

FIG. 17 is an example of one table included in an answerer score data file.

FIG. 18 is an example of one table in which administrator account information in a project administrator account file is stored.

FIG. 19 is an example of one table in which administrator account information in a server administrator account file is stored.

FIG. 20 is an example of one table in which the progress status included in the evaluation progress management file is stored.

FIG. 21 is an example of one table in which the progress status included in the answer progress management file is stored.

FIG. 22 shows an example of a screen displayed on an evaluator terminal when an evaluation session is carried out.

FIG. 23 shows an example of a screen displayed on an answerer terminal when a collection session is carried out.

FIG. 24 is an example of a screen of a participant page displayed on a participant terminal.

FIG. 25 is an example of a menu screen of a project administrator page displayed on a project administrator terminal.

FIG. 26 is an example of a menu screen of a server administrator page displayed on a server administrator terminal.

FIG. 27A is an example of a question setting screen of a collection session displayed on the project administrator terminal.

FIG. 27B is an example of a question setting screen of an evaluation session displayed on a project administrator terminal.

FIG. 28 is an example of a screen having an input column for inputting a question title (a simple name representing a question theme that can be used as an index) and a simple explanatory text explaining the purpose of the question.

FIG. 29 is an example of a project implementation condition setting screen displayed on the project administrator terminal.

FIG. 30 is a number line for explaining a method of adjusting the degree of strictness of an evaluator.

FIG. 31 is an example of data relating to an evaluation target displayed on a project administrator terminal.

FIG. 32 is an example of data related to an answerer displayed on a project administrator terminal.

FIG. 33 is an example of data related to an evaluator displayed on a project administrator terminal.

FIG. 34 is a flowchart showing a procedure in which a project administrator accesses a server to input project implementation conditions and register participants.

FIG. 35 is a flowchart showing a processing flow from the start to the end of a collection session.

FIG. 36 is a flowchart showing a processing flow from the start to the end of an evaluation session.

FIG. 37 is a flowchart showing a processing flow in which an evaluation analysis is performed by an evaluation analysis part of a server after the end of the evaluation session and the result is transmitted to a participant terminal and a project administrator terminal.

FIG. 38 is an example of a screen for selecting a population of evaluation targets (in here, answers) displayed on a project administrator terminal.

### DETAILED DESCRIPTION OF THE INVENTION

Hereinafter, embodiments of the method for online evaluation and the online server for evaluation according to the present invention will be described in detail with reference to the drawings, but the present invention is not limited to these embodiments. In the following description, a person who participates in an evaluation session and evaluates an evaluation target is referred to as an “evaluator”, and a person who participates in a collection session and provides information to be evaluated is referred to as an “answerer”. A participant may participate in only one of the evaluation session and the collection session, or both. It can be decided in advance which session the participant will participate in. Further, although embodiments in which both the collection session and the evaluation session are carried out will be described here, the evaluation session may be carried out alone.

<1. System Configuration>

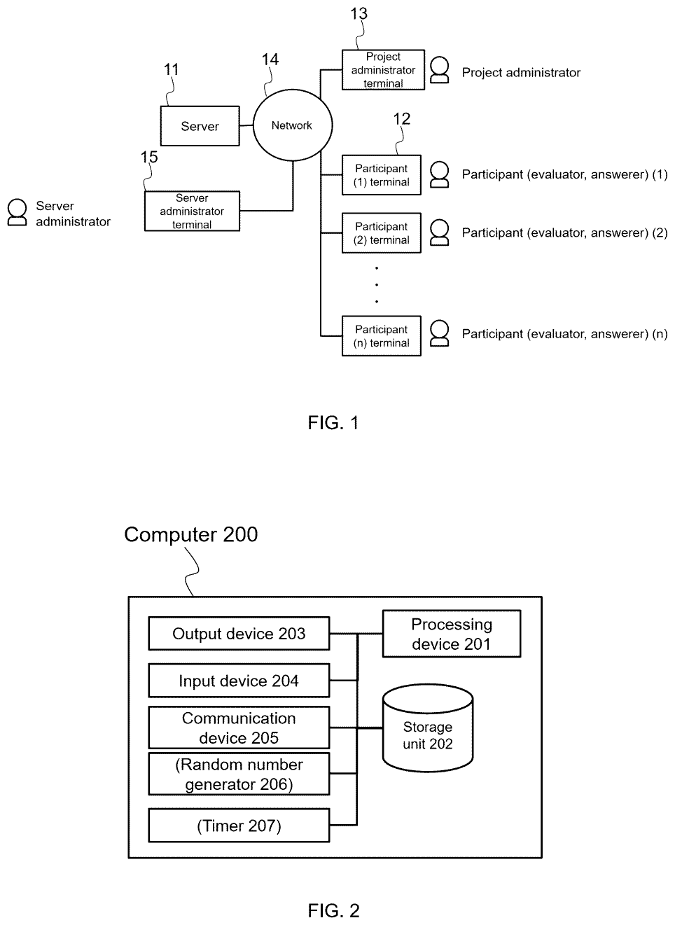

FIG. 1 shows the overall configuration of a system for performing the method for online evaluation according to the present embodiment. The system comprises a server 11, a plurality of participant terminals 12 from the first to the n^{th}, a project administrator terminal 13, and a server administrator terminal 15. The participant terminal 12, the project administrator terminal 13, and the server administrator terminal 15 are connected to the server 11 so as to be able to communicate with each other through a computer network 14 such as the Internet, a dedicated line, or a public network. The server administrator terminal 15 is not necessarily required as a terminal independent of the server 11, and the function of the server administrator terminal 15 can also be realized by the server 11.

[Network]

The computer network 14 is not limited, but can be, for example, a wired network such as a LAN (Local Area Network) or a WAN (Wireless Network), and can be a wireless network such as WLAN (Wireless Local Area Network) using MIMO (Multiple-Input Multiple-Output). Alternatively, an Internet using a communication protocol such as TCP/IP (Transmission Control Protocol/Internet Protocol), or it may be via a base station (not shown) that plays a role as a so-called Wireless LAN Access Point.

The server means a server computer, and can be configured by the cooperation of one or a plurality of computers. The participant terminal 12, the project administrator terminal 13, and the server administrator terminal 15 can be realized by a personal computer equipped with a browser, but the present invention is not limited thereto. They can be composed of portable terminals such as smartphones, tablets, mobile phones, mobiles and PDAs, and devices and apparatus capable of communication via a computer network such as digital televisions.

The basic hardware configurations of the server 11, the participant terminal 12, the project administrator terminal 13, and the server administrator terminal 15 are common. As shown in FIG. 2, they can be realized by a computer 200 having a processing device 201, a storage device 202, an output device 203, an input device 204, and a communication device 205. Further, a random number generator 206 and a timer 207 may be provided as needed.

The processing device 201 refers to a device, a circuit, or the like that controls the entire computer and executes arithmetic processing according to commands, instructions and data input by the input device 204, or data stored in the storage device 202, and the like. As the processing device 201, for example, a CPU (Central Processing Unit), an MPU (Micro Processing Unit), or the like can be adopted.

The storage device 202 refers to a device, a circuit, or the like that store various data, operating systems (OS), network applications (example: a web server software on the server 11 side, and browsers on the participant terminal 12, the project administrator terminal 13, and the server administrator terminal 15), and programs for executing various arithmetic processes, and the like. For example, known storage devices such as a primary storage device that mainly use semiconductor memory, a secondary storage device (auxiliary storage device) that mainly use hard disk drives and semiconductor disks, offline storage and tape libraries that mainly uses removable media drives such as CD-ROM drives may be used. More specifically, in addition to magnetic memory storage devices such as hard-disk drives, Floppy™ disks drives, zip drives and tape storages, storage devices or storage circuits employing semiconductor memory such as registers, cache memory, ROM, RAM, flash memory (such as USB storage devices or solid state drive), semiconductor disks (such as RAM disks and virtual disk drives), optical storage media such as CDs and DVDs, optical storage devices employing magneto-optical disks like MO, other storage devices such as paper tapes and punch cards, storage devices employing phase change memory technique called PRAM (phase change RAM), holographic memory, storage devices employing 3-dimensional optical memory, storage devices employing molecular memory which stores information through accumulating electrical charge at a molecular level, and the like may be used.

The output device 203 refers to an interface such as a device or circuit that enables output of data or commands, and a display such as LCD and OEL as well as a printer or a speaker, and the like can be employed.

The input device 204 refers to an interface to pass data or commands to the processing device 201, and a keyboard, a numeric keypad, a pointing device such as a mouse, a touch panel, a reader (OCR), an input screen and an audio input interface such as a microphone may be employed.

The communication device 205 refers to a device or a circuit for transmitting and receiving data to/from the outside the computer, and may be an interface such as a LAN port, a modem, wireless LAN and a router. The communication device 205 can transmit/receive the processed results by the processing device 201 and the information stored in the storage device 202 through the computer network 14.

The random number generator 206 is a device which is able to provide random numbers.

The timer 207 is a device which is able to measure and inform time.

[Server]

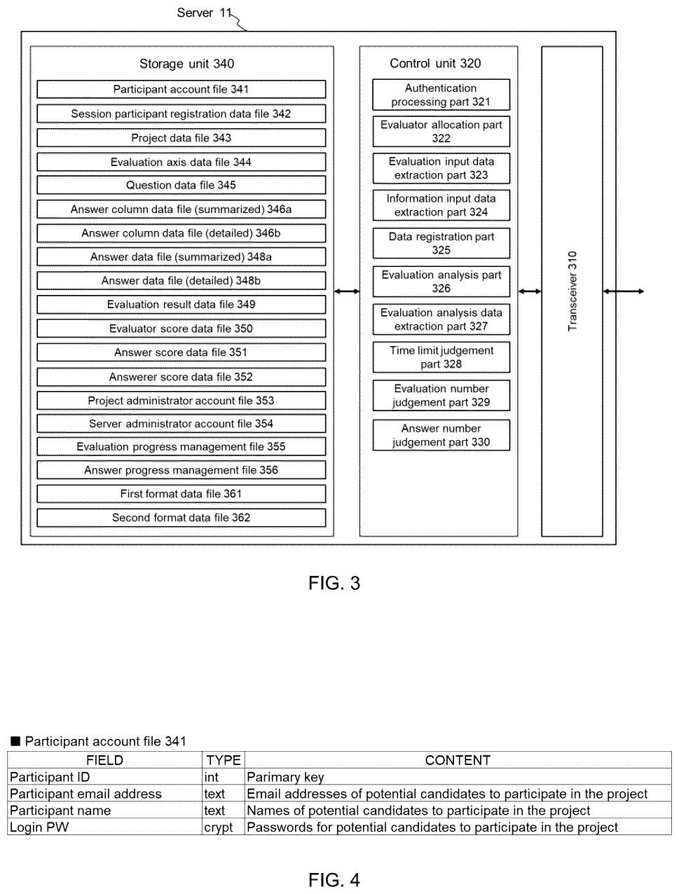

FIG. 3 shows an example of a functional block diagram of the server 11. The server 11 comprises a transceiver 310, a control unit 320 and a storage unit 340.

<Storage Unit>

In the present embodiment, the storage unit 340 of the server 11 may store a participant account file 341, session participant registration data file 342, a project data file 343, an evaluation axis data file 344, a question data file 345, an answer column data file (summarized) 346a, an answer column data file (detailed) 346b, an answer data file (summarized) 348a, an answer data file (detailed) 348b, an evaluation result data file 349, an evaluator score data file 350, an answer score data file 351, an answerer score data file 352, a project administrator account file 353, a server administrator account file 354, an evaluation progress management file 355, an answer progress management file 356, and the like. These files may be prepared individually according to the type of data, or a plurality of types of files may be collectively stored in one file. Further, the data included in the same file name may be stored in a plurality of files separately. The data stored in these various files may be temporarily or non-transitory stored in these files depending on the type of data.

Further, the storage unit 340 of the server 11 may store a first format data file 361 for storing first format data for evaluation input including a selective evaluation input section based on at least one evaluation axis, and a second format data file 362 for storing second format data including at least one information input section. These files may be prepared individually according to the type of data, or a plurality of types of data may be collectively stored in one file. Further, the same type of data may be stored in a plurality of files separately.

(Participant Account File)

The participant account file 341 may store the account information of candidates who may participate in a collection session and/or an evaluation session in a searchable state. FIG. 4 shows an example of one table in which the account information of one participant included in the participant account file 341 is stored. The table may store the participant ID as the identifier of the participant, the participant's email address, the participant's name, the organization ID that is the identifier of the organization to which the participant belongs, the ID within the organization such as employee number, the department name, the date of birth, the zip code, the address, the account opening date and time, the login PW, and the like.

(Session Participant Registration Data File)

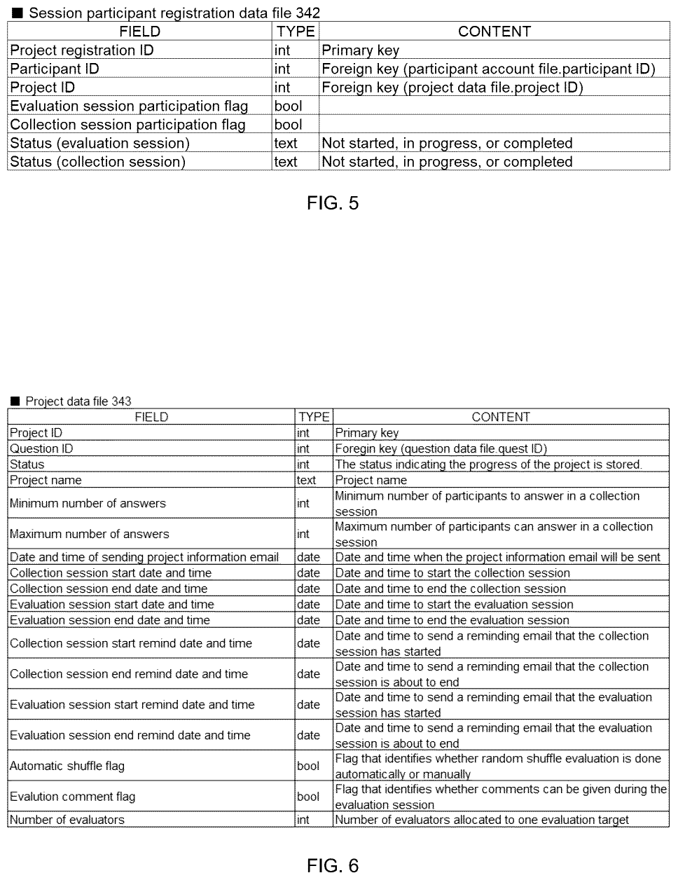

The session participant registration data file 342 may store information about which participant stored in the participant account file 341, will or will not participate in the collection or the evaluation session in a searchable state. In addition, the session participant registration data file 342 can also store information about the status of each participant's session in a searchable state. FIG. 5 shows an example of one table in which session participation information of one participant included in the session participant registration data file 342 is stored. The table is provided with fields for an evaluation session participation flag and a collection session participation flag, which are associated with the participant ID of the participant, and the fields for the session in which the participant participates are flagged. It may be decided by the project administrator whether or not the participant participates in the collection session or the evaluation session, or it may be decided by the participant's will. It may be determined by other means as well.

(Project Data File)

The project data file 343 may store information about implementation conditions of a project that conducts a collection session and/or an evaluation session on a given theme in a searchable state. FIG. 6 shows an example of one table in which information about the project implementation conditions included in the project data file 343 is stored. The table may store information such as the project ID that is the identifier of the project, the question ID, the status, the project name, the minimum number of answers, the maximum number of answers, date and time when the project invitation email will be sent, collection session start date and time, collection session end date and time, evaluation session start date and time, evaluation session end date and time, collection session start remind date and time, collection session end remind date and time, evaluation session start remind date and time, evaluation session end remind date and time, automatic shuffle flag, evaluation comment flag, and number of evaluators. The larger the number of evaluators for one evaluation target is, the higher the objectivity is because evaluations from many evaluators can be collected. Therefore, it is preferable to have a plurality of evaluators, more preferably 5 or more evaluators, and even more preferably 10 or more evaluators. However, a reasonable number of people (example: in the range of 5 to 20) may be set in consideration of the evaluation time and the number of evaluators. Information about the project implementation conditions may be stored together in one file, or may be stored separately in a plurality of files.

(Evaluation Axis Data File)

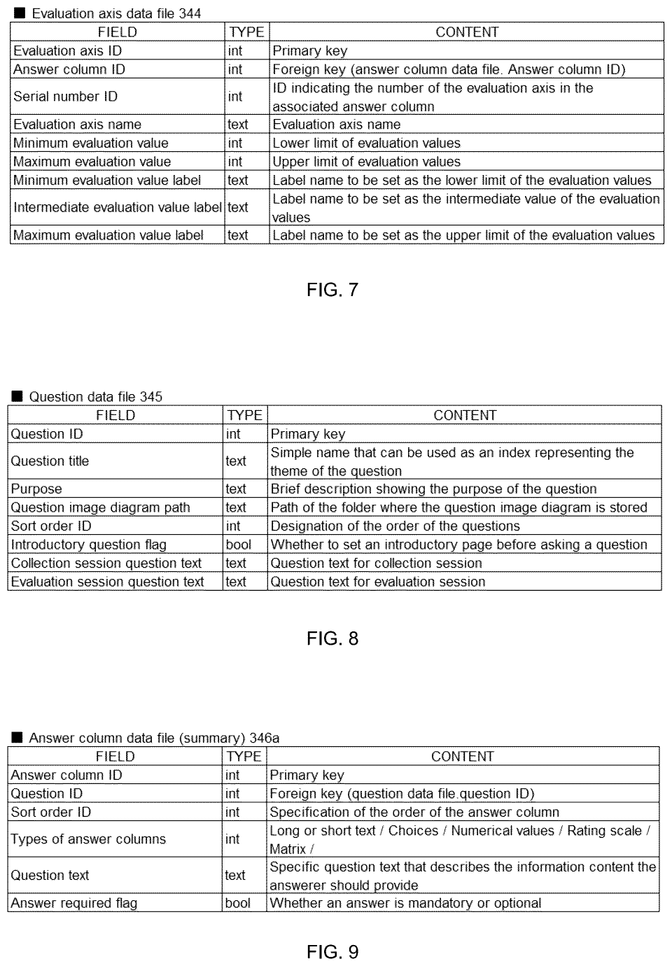

The evaluation axis data file 344 may store information about the evaluation axis used when evaluating the evaluation target in a searchable state. This information can be regarded as a kind of information about the implementation conditions of the project. When there is a plurality of evaluation axes, the evaluation axis data file 344 stores information about the plurality of evaluation axes. FIG. 7 shows an example of one table in which information about one evaluation axis included in the evaluation axis data file 344 is stored. The table may store information such the evaluation axis ID that is the identifier of the evaluation axis, the answer column ID, the serial number ID, the evaluation axis name, the minimum evaluation value, the maximum evaluation value, the minimum evaluation value label, the Intermediate evaluation value label, and the maximum evaluation value label. In this embodiment, the evaluation target is the information collected from the answerers in the collection session. However, the evaluation target is not limited to the information collected in the collection session.

The evaluation axis name describes the viewpoint of evaluation when an evaluator evaluates the evaluation target. The viewpoint of evaluation may be appropriately set according to the evaluation target. From the viewpoint of evaluation, for example, when evaluating a business idea, novelty, innovativeness, growth potential, social contribution, unexpectedness, sympathy, and the like can be mentioned. In addition, when evaluating corporate value, the growth potential of the evaluated company, the stability of the evaluated company, the social contribution of the evaluated company, and the like can be mentioned. In addition, the viewpoint of evaluation may simply be whether or not to agree or sympathize with the answer from the answerer. Further, in addition to the evaluation axis for evaluating individual items, an evaluation axis named comprehensive evaluation may be provided. This makes it possible to visualize “which evaluation axis has the greatest influence on the comprehensive evaluation” by performing a multiple regression analysis of the relationship between the evaluation of individual items and the comprehensive evaluation from all evaluators. However, as will be described later, a comprehensive evaluation can also be calculated from the evaluation results on each evaluation axis.

At least one evaluation axis is required for one evaluation target. In order to make evaluation from various aspects, it is preferable that the number of evaluation axes be two or more, and more preferably three or more.

(Question Data File)

The question data file 345 may store information about the questions presented to the answerers when a collection session is conducted and information about the questions presented to the evaluators when an evaluation session is conducted in a searchable state. The above information can be regarded as a kind of information regarding the implementation conditions of the project. In the present embodiment, the information about the questions presented to the answerers when a collection session is conducted and the information about the questions presented to the evaluators when an evaluation session is conducted are stored in the question data file 345 as a set, but for example, when the collection session and the evaluation session are performed independently, these two types of information may be stored separately in a plurality of files. FIG. 8 shows an example of one table in which information about questions included in the question data file 345 is stored. The table may store information such as the question ID that is the identifier of the question data, the sort order ID, the introduction question flag, the question title, the collection session question text, and the evaluation session question text.

The theme of the question is not particularly limited, but examples include brainstorming of ideas, penetration of a vision, and quantification of the five senses.

(Answer Column Data File (Summarized))

The answer column data file (summarized) 346a may store information about the answer column to be presented to the answerers when a collection session is conducted in a searchable state. This information can be regarded as a kind of information about the implementation conditions of the project. FIG. 9 shows an example of one table in which information about one answer column included in the answer column data file (summarized) 346a is stored. The table may store information such as the answer column ID that is the identifier of the answer column data, the question ID, the sort order ID, the answer column type, the question text (a type of question data), and the answer required flag. There are no particular restrictions on the type of answer column, and mention can be made to short text, long text, dropdown, check box, radio button, numerical input, file upload, rating (example: type of answer column for evaluating N grades (N=3 to 11)), matrix, text matrix, and the like. It is preferable that at least text information can be input in the answer column because the individuality and ideas of the answerers can be easily expressed.

(Answer Column Data File (Detailed))

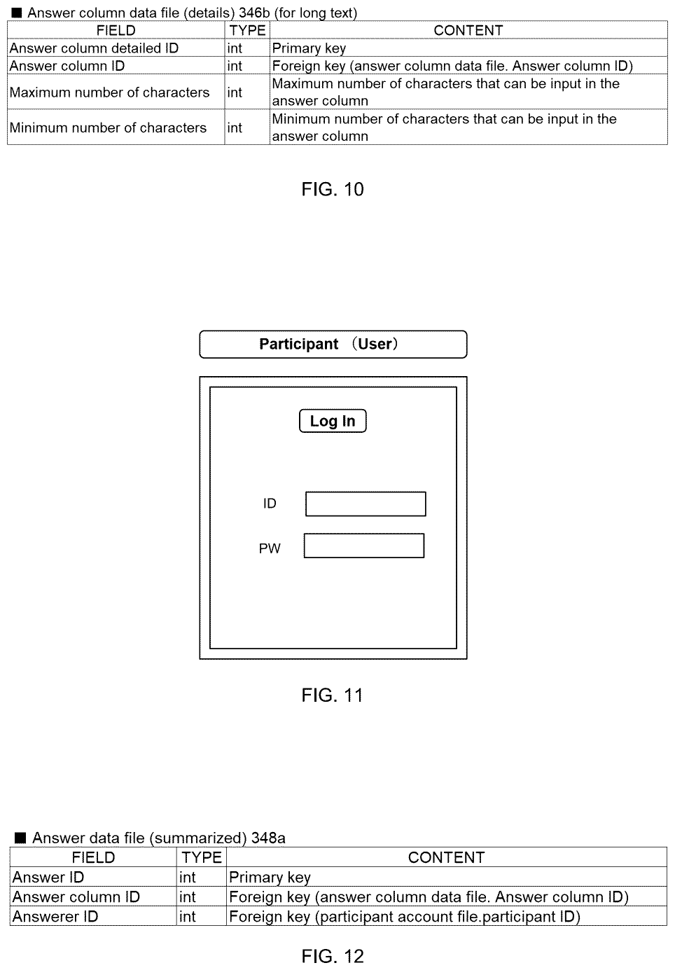

The answer column data file (detailed) 346b may store information about detailed conditions according to the type of answer column presented to the answerers when a collection session is conducted in a searchable state. This information can be regarded as a kind of information about the implementation conditions of the project. FIG. 10 shows an example of one table in which information about detailed conditions for one answer column included in the answer column data file (detailed) 346b is stored. The table, for example, when the type of answer column is “long text”, may store information such as the maximum number of characters, minimum number of characters, along with the answer column detail ID and answer column ID that serve as identifiers.

(Answer Data File (Summarized))

The answer data file (summarized) 348a may store such as the identifier of the answer data including the information about a predetermined theme (in other words, the answer to the question) transmitted by the answerer in the collection session in a searchable state. The information contained in the answer data can be used for evaluation. FIG. 12 shows an example of one table included in the answer data file (summarized) 348a. The table may store the answer ID that is the identifier of the answer data, the answerer ID that is the identifier of the answerer who has transmitted the answer data, and the answer column ID used for the answer.

(Answer Data File (Detailed))

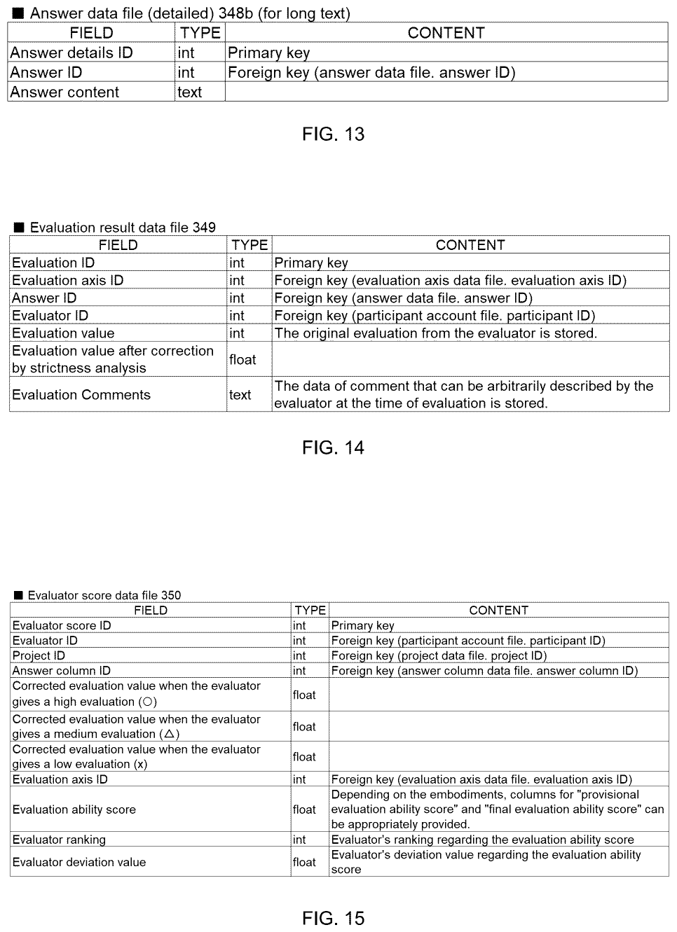

The answer data file (detailed) 348b may store information about the specific contents of the answer data according to the type of the answer column in a searchable state. FIG. 13 shows an example of one table in which information about the specific contents of one answer data included in the answer data file (detailed) 348b is stored. The table, for example, when the type of answer column is “long text”, may store information such as the answer content created in long text along with the answer detail ID and answer ID that serve as identifiers.

The answer data files 348a and 348b may store only the answer data collected by the current collection session, but may also store the answer data collected by collection sessions in the past. Further, the storage unit of the server 11 may have an evaluation target data storage part that stores information that can be an evaluation target in addition to the answer data collected by the current or past collection session. All the information stored in the evaluation target data storage part may be the evaluation target of the current evaluation session, or only a part of the information may be the evaluation target of the current evaluation session.

(Evaluation Result Data File)

The evaluation result data file 349 may store evaluation result data including the evaluation by the evaluators for the information from the answerers as the evaluation target in the present embodiment and the corrected evaluation after analyzing the degree of strictness of the evaluator for each evaluation axis, in a searchable state. FIG. 14 shows an example of one table included in the evaluation result data file 349. The table may store the evaluation ID that is the identifier of the evaluation result data, the evaluation axis ID, the answer ID that is the identifier of the answer data including the information as the evaluation target, the evaluator ID, the evaluation value by the evaluator, the corrected evaluation after analyzing the degree of strictness, the descriptive comments by the evaluators, and the like. The contents of the selective evaluation and the contents of the descriptive evaluation can be stored for each evaluation axis.

For example, the evaluation value may be a three-choice type such as “I do not agree very much”, “I can agree”, or “I can agree very much”, or a two-choice type such as “I agree” or “I do not agree”. It may be expressed by a score within a predetermined range. The evaluation value can be stored for each evaluation axis described above. By performing the evaluation of the evaluation target with a selective evaluation, the evaluation data of the evaluation target can be statistically analyzed easily by the selective evaluation. The selective evaluation includes, but is not limited to, a method of selecting one of options displayed in advance, a method of inputting a numerical value related to the grade of the evaluation, and the like. Further, the evaluation result data file 349 may store comment data that can be arbitrarily described by the evaluator at the time of evaluation.

(Evaluator Score Data File)

The evaluator score data file 350 is a kind of evaluator score data storage part. It may store an evaluation ability score for each evaluation axis corresponding to the connoisseurship of the evaluator in a searchable state. The evaluation value of the evaluation target by one evaluator and the score acquired by the evaluation target based on the evaluation of the evaluation target from all the evaluators (in this embodiment, the “answer score”) are compared for each evaluation axis. The higher the closeness between the two is, the higher the evaluation ability score of the evaluator is. FIG. 15 shows an example of one table included in the evaluator score data file 350. The table may store the evaluator score ID that is the identifier of the evaluator score data, the evaluator ID that is the identifier of the evaluator, the evaluation axis ID, the evaluation ability score of the evaluator, and the like. Depending on the embodiment, a “provisional evaluation ability score” and a “final evaluation ability score” can also be stored. The provisional evaluation ability score may be stored in a temporary file, and the temporary file for temporarily storing the provisional evaluation ability score is also a kind of evaluator score data storage part. Further, the evaluator score data file 350 may store the project ID, the answer column ID associated with the information evaluated by the evaluator, the rank of the evaluator regarding the evaluation ability score, the deviation value of the evaluator regarding the evaluation ability score, and the like.

(Answer Score Data File)

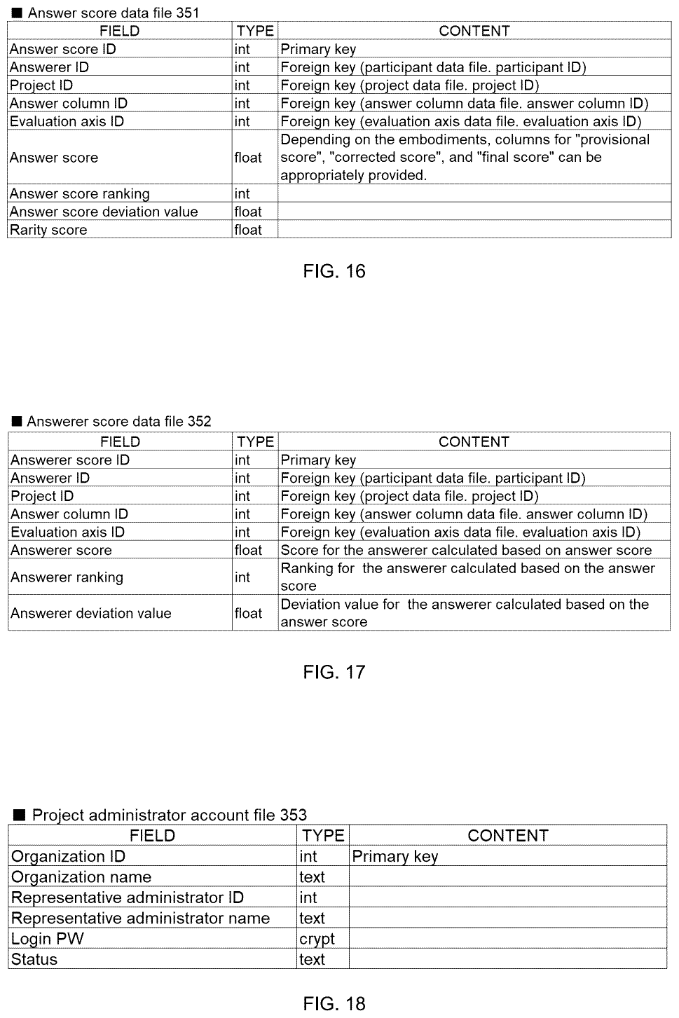

The answer score data file 351 is a kind of evaluation target score data storage part. It may store an answer score acquired by the information from the answerer as the evaluation target based on the evaluations from all the evaluators for each evaluation axis in a searchable state. The answer score includes a provisional score, a corrected score, and a final score, and one or more of these can be stored depending on the embodiments. The provisional score and the corrected score may be stored in a temporary file, and the temporary file for temporarily storing the provisional score and the corrected score is also a kind of evaluation target score data storage part. FIG. 16 shows an example of one table included in the answer score data file 351. The table may store the answer score ID that is the identifier of the answer score data, the answerer ID which is the identifier of the answerer, the evaluation axis ID, the answer column ID associated with the information, the answer score of the information, and the like. Further, the answer score data file 351 may store the project ID, the rank of the answer score acquired by the information, the deviation value of the answer scores acquired by the information, the rarity score, and the like.

(Answerer Score Data File)

The answerer score data file 352 is a kind of answerer score data storage part. It may store a score of the answerer calculated based on the answer score acquired by the information as the evaluation target (the “answerer score”) for each evaluation axis in a searchable state. In general, answerers who provide information that has acquired a high answer score (information that is highly evaluated by the evaluators) are given a high answerer score. FIG. 17 shows an example of one table included in the answerer score data file 352. The table may store the answerer score ID that is the identifier of the answerer score data, the answerer ID that is the identifier of the answerer, the evaluation axis ID, the answerer score, and the like. Further, the answerer score data file 352 may store the project ID, the answer column ID associated with the information answered by the answerer, the rank of the answer regarding the answerer score, the deviation value of the answer regarding the answerer score, and the like.

(Project Administrator Account File)

The project administrator account file 353 may store account information for the administrator of a project that conducts a collection session and/or an evaluation session on a given theme, for example, the account information of the organization such as a company to which the answerers and/or the evaluators belong in a searchable state. FIG. 18 shows an example of a table in which the administrator account information in the project administrator account file 353 is stored. If the administrator is an organization such as a company, the table may store the organization ID, the organization name, the name of the representative of the organization, the representative ID, the zip code and address of the organization, the name, telephone number and email address of the department in charge, the account opening date and time, the login PW, the status, and the like. The status includes information about the existence of the administrator account, such as “closed account”.

(Server Administrator Account File)

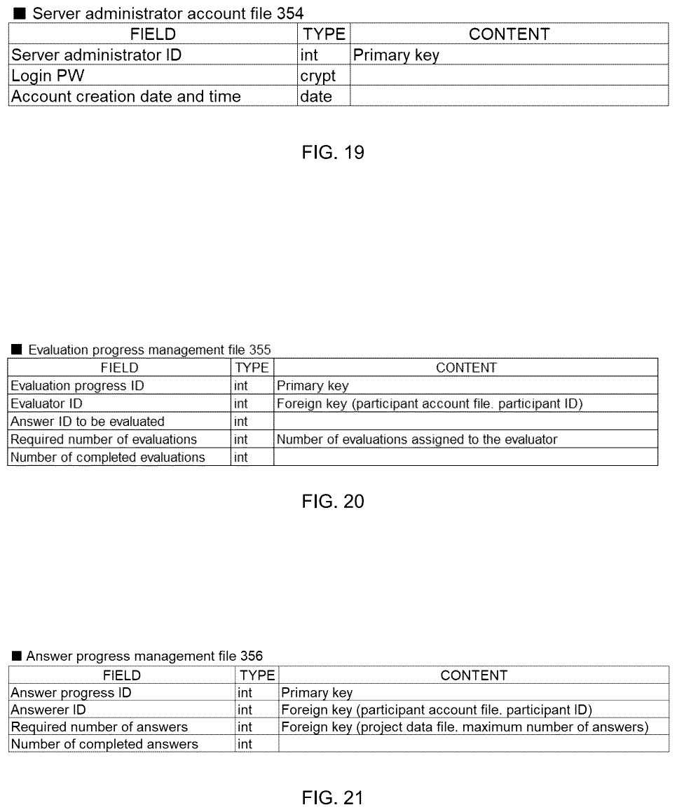

The server administrator account file 354 may store the server administrator account information in a searchable state. FIG. 19 shows an example of a table in which the administrator account information in the server administrator account file is stored. The table may store the server administrator ID that is the identifier of the server administrator, the login password (PW), the account creation date and time, the authority level, and the like.

(Evaluation Progress Management File)

The evaluation progress management file 355 may store information about the progress of the evaluation session. FIG. 20 shows an example of a table in which the progress status included in the evaluation progress management file 355 is stored. It is possible to store the evaluator ID of the evaluator, the identifier of the evaluation target such as the answer ID to be evaluated by the evaluator, the required number of evaluations, the number of completed evaluations, and the like. The evaluation progress management file 355 may be a temporary file.

(Answer Progress Management File)

The answer progress management file 356 may store information about the progress of the collection session. FIG. 21 shows an example of a table in which the progress status included in the answer progress management file 356 is stored. It is possible to store the answerer ID of the answerer, the number of questions that the answerer should answer (the number of required answers), the number of completed answers, and the like. The answer progress management file 356 may be a temporary file.

In the above tables in the data files, data types such as “int” (integers), “text” (character string type), “float” (floating point type), “crypt” (encrypted character string type) and “date” (date and time type), bool (true and false binary type) are used for each filed. However, the data types are not limited to the illustrated forms, and may be appropriately changed as needed.

(First Format Data File)

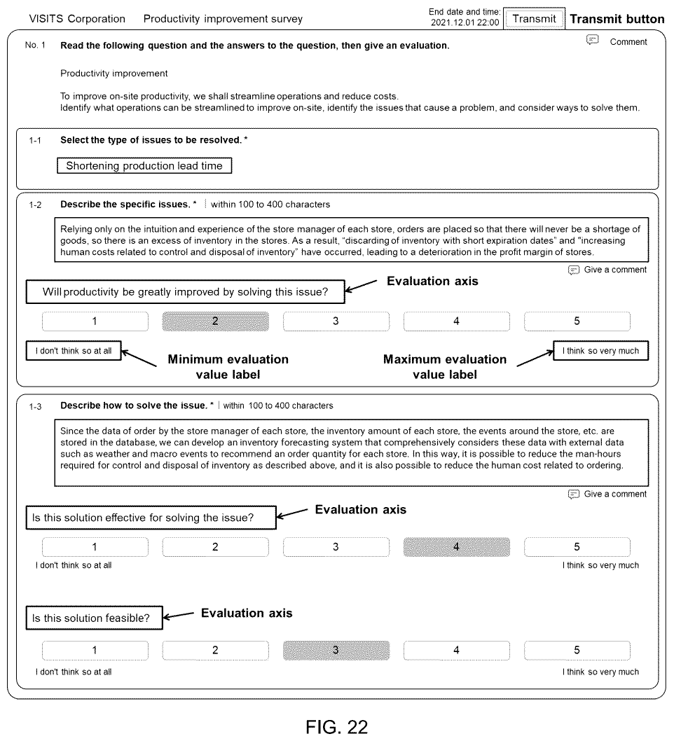

First format data file 361, which is a type of the first format data storage part, may store first format data for evaluation input, including a selective evaluation input section based on at least one evaluation axis, which is used to carry out the evaluation session. As mentioned above, the selective evaluation makes it easier to statistically analyze the evaluation data for the evaluation target. The first format data may further include at least one descriptive comment input section. A descriptive evaluation increases the degree of freedom of description, so that the reader can deeply understand the evaluator's way of thinking and the basis of the evaluation. FIG. 22 shows an example of a screen displayed on the evaluator terminal 12 based on the information about the answer content (the evaluation target) stored in the answer data file (detailed) 348b, the evaluation input conditions for each evaluation axis stored in the evaluation axis data file 344, and the first format data for evaluation input including a selective evaluation input section. The first format data may have places where other information (such as the question text of the collection session and the question text of the evaluation session stored in the question data file 345, and the question text stored in the answer column data file (summarized) 346a, and the like) is displayed on the screen as appropriate.

(Second Format Data File)

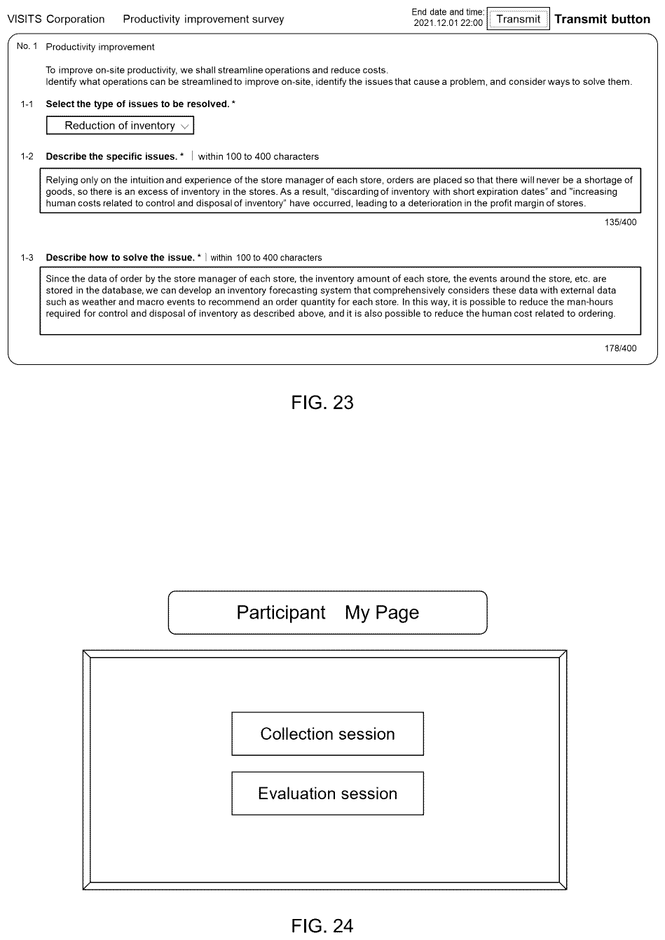

The second format data file 362, which is a type of the second format data storage part, may store second format data including at least one information input section (in this embodiment, the “answer column”), which is used to carry out the collection session. As long as information that reflects the answerer's thoughts can be input in the answer column, there are no particular restrictions on the input method, but it is preferable that the answer column include an input section for text information. Answerers can input answers to questions about a predetermined theme in the answer column. The format of the answer column is determined according to the conditions specified in the answer column data file (summarized) 346a and the answer column data file (detailed) 346b, and the second format data that meet the conditions is sent to the answerers. FIG. 23 shows a screen displayed on the answerer terminal 12 based on the second format data extracted according to the conditions of the answer column stored in the answer column data file (summarized) 346a and the answer column data file (detailed) 346b. It may have a place where the question text of the collection session stored in the question data file 345 is to be displayed on the screen in combination as appropriate. On the screen shown in FIG. 23, the answer input by the answerer is displayed in the answer column.

<Transceiver>

The server 11 can exchange various data with the participant (evaluator, answerer) terminal 12, the project administrator terminal 13, the server administrator terminal 15, and the computer network 14 through the transceiver 310.

For example, the transceiver 310 may be capable of:
receiving various conditions related to the collection session and the evaluation session from the project administrator terminal 13;
in the evaluation session, transmitting the data related to a plurality of evaluation targets (in this embodiment, information about a predetermined theme transmitted by the answerer), the question data, and the first format data to the corresponding terminals of the plurality of evaluators in a displayable form;
in the evaluation session, performing a step 1C comprising receiving the evaluation result data including the evaluation of the evaluation target input by each evaluator in the selective evaluation input section from the terminal of each evaluator;
transmitting various evaluation analysis data for the evaluation target to the project administrator terminal 13 in a displayable form;
transmitting various data related to the evaluator, such as the evaluation ability score of the evaluator, to the project administrator terminal 13 in a displayable form;
in the collection session, transmitting the question data and the second format data to the terminals of a plurality of answerers in a displayable form;
in the collection session, performing a step 2B comprising receiving the answer data including the information about the predetermined theme input by each answerer from the terminal of each answerer;
transmitting various data related to the answerer, such as the score of the answerer, to the project administrator terminal 13 in a displayable form.

<Control Unit>

In the present embodiment, the control unit 320 of the server 11 comprises an authentication processing part 321, an evaluator allocation part 322, an evaluation input data extraction part 323, an information input data extraction part 324, a data registration part 325, an evaluation analysis part 326, an evaluation analysis data extraction part 327, a time limit judgement part 328, an evaluation number judgement part 329, and an answer number judgement part 330. Each part can perform the desired calculation based on the program.

(Authentication Processing Part)

The authentication processing part 321 can authenticate the participant ID and password based on the access request from the participant (evaluator, answerer) terminal 12. For example, the access request from the participant terminal 12 can be executed by inputting the participant ID and password and clicking a login button on a screen of a top page on the participant terminal 12 as shown in FIG. 12. The participant ID and password of each examinee may be given in advance by the server administrator. The authentication processing may be executed by the authentication processing part 321 which refers to the participant account file 341 and determines whether or not the input participant ID and password match the data stored in the participant account file 341. If the input participant ID and password match the stored data, the screen data of the participant page (for example, a menu screen shown in FIG. 24) can be transmitted from the transceiver 310 to the corresponding participant terminal 12. If not matching, an error message may be transmitted.

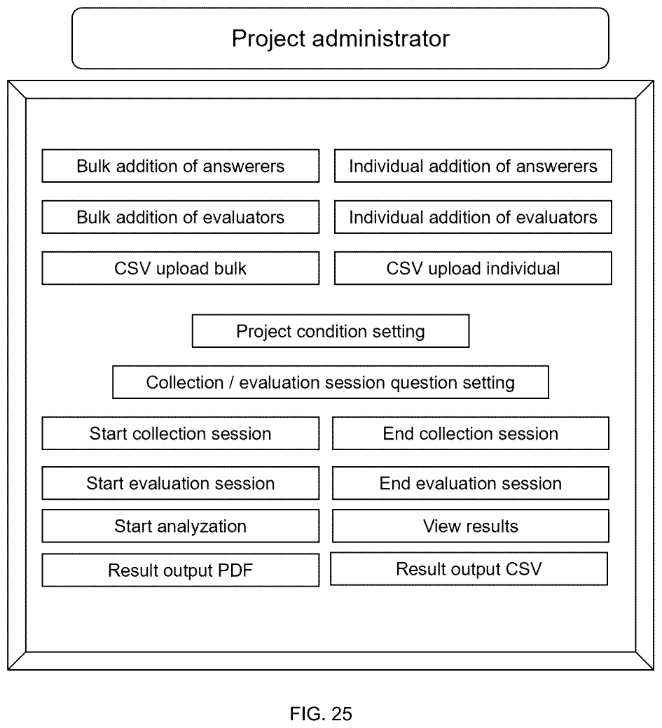

In addition, the authentication processing part 321 may authorize an organization ID and password based on an access request from the project administrator terminal 13. The organization ID and password may be given in advance by the server administrator. The authentication processing may be executed by the authentication processing part 321 which refers to the project administrator account file 353 and determines whether or not the input organization ID and password match the data stored in the project administrator account file 353. If the input organization ID and password match the stored data, the screen data of the project administrator page as shown in FIG. 25 can be transmitted from the transceiver 310 to the corresponding project administrator terminal 13. If not matching, an error message may be transmitted.

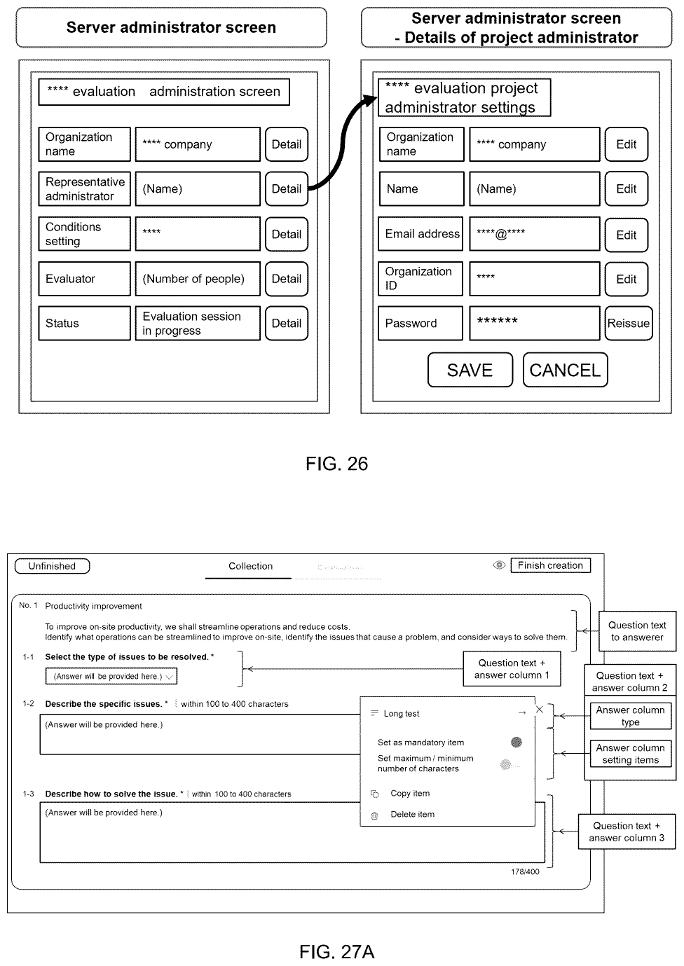

In addition, the authentication processing part 321 may authorize a server administrator ID and password based on an access request from the server administrator terminal 15. The administrator ID and password of the server administrator may be given in advance by himself/herself. The authentication processing may be executed by the authentication processing part 321 which refers to the server administrator account file 354 and determines whether or not the input server administrator ID and password match the data stored in the server administrator account file 354. If the input server administrator ID and password match the stored data, the screen data of the server administrator page (for example, the administration screen shown in FIG. 26) can be transmitted from the transceiver 310 to the corresponding server administrator terminal 15. If not matching, an error message may be transmitted.

(Data Registration Part)

The data registration part 325 may register the participants (evaluators, answerers). For example, when a project administrator such as a company to which the participants belong logins using the project administrator terminal 13 according to the above procedures, a project administrator screen as shown in FIG. 25 will be displayed on the project administrator terminal 13. When the project administrator clicks a button of “Bulk addition of evaluators” or a button of “Individual addition of evaluators”, a screen for inputting the account information of the evaluator (not shown) will be displayed on the project administrator terminal 13, and on this screen, the predetermined evaluator account information to be stored in the participant account file 341 such as an evaluator's individual ID, evaluator ID, organization ID of the organization to which the evaluator belongs, and employee number. Once the input has been completed, by clicking a predetermined button such as “Save” or “Confirm” on the screen, the evaluator account information can be transmitted to the server 11. Alternatively, when the project administrator clicks a button of “CSV upload bulk” or a button of “CSV upload individual”, a screen for selecting a file saved in the project administrator terminal 13 or the like is displayed, and by selecting the desired file in which the participant account information is stored and clicking a predetermined button such as “Transmit”, the participant account information can be transmitted to the server 11. In this way, the transceiver 310 in the server 11 can receive the participant account information transmitted to the server 11, and the data registration part 325 can store the received information in the participant account file 341.

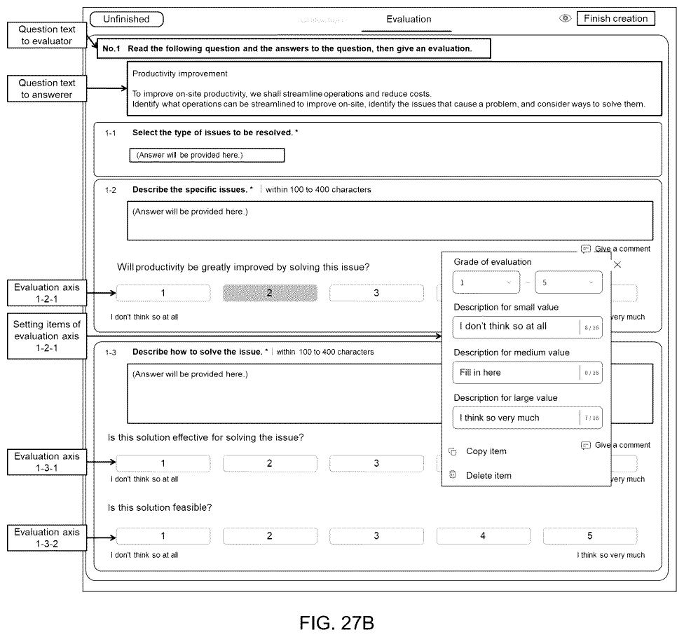

In addition, the data registration part 325 may register the project implementation conditions including collection and evaluation sessions. For example, when the project administrator clicks a button of “Collection/evaluation session question setting” on the project administrator screen as shown in FIG. 25, the screen will be shift to a question setting screen for collection session as shown in FIG. 27A. On this screen, the project administrator can input information about the collection session to be stored in the question data file 345, the answer column data file (summarized) 346a, and the answer column data file (detailed) 346b, such as question text (text that present the theme) regarding the predetermined theme to be presented to the answerers, question text to be presented to the answerers for each answer column, types of the answer columns, and the like. In addition, the question setting screen of the collection session is provided with a button that can be switched between the question setting screen of the evaluation session. For example, when the project administrator clicks the “evaluation” button on the question setting screen of the collection session, the screen switches to the question setting screen of the evaluation session as shown in FIG. 27B. On this screen, the project administrator can input information about the evaluation session questions that should be stored in the question data file 345 and the evaluation axis data file 344, such as evaluation axis name, minimum evaluation value, maximum evaluation value, minimum evaluation value label, central evaluation value label, maximum evaluation value label, and the like. Questions to the answerers in the collection session can also be displayed on the question setting screen of the evaluation session. This allows the project administrator to set the questions in the evaluation session while referring to the questions to the answerers in the collection session.

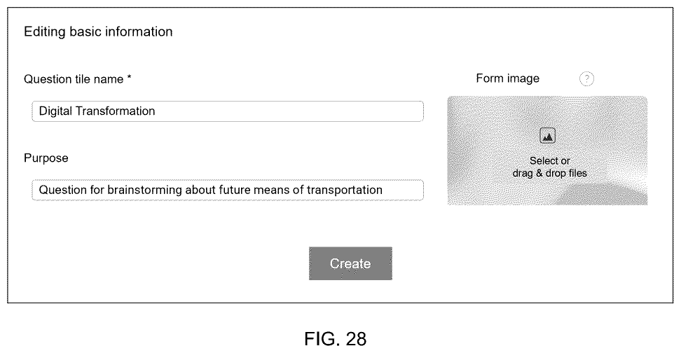

After inputting the information about the questions in the collection session and the information about the questions in the evaluation session, when the administrator clicks the “Finish creation” button, as shown in FIG. 28, a screen having an input column for inputting a question title (a simple name indicating the theme of the question that can be used as an index) used in the project and a simple description explaining the purpose of the question is displayed, and these can be input in the input column. Further, it is possible to be configured that a simple image related to the question title can be selected based on a file name, or can be selected by dragging and dropping it to a predetermined position on the screen. Question titles and the like can also be treated as a type of information related to questions in the collection session or information related to questions in the evaluation session. After that, when the administrator clicks the “Create” button, the information about the questions in the collection session and the information about the questions in the evaluation session can be transmitted to the server 11.

In addition, the question titles and the like can be input simultaneously on the question setting screen of the collection session as shown in FIG. 27A, on the question setting screen of the evaluation session as shown in FIG. 27B, or on another screen. It also can be input on another screen before inputting information about the questions of the collection session on the question setting screen of the collection session as shown in FIG. 27A, or before inputting the information about the questions of the evaluation session on the question setting screen of the evaluation session as shown in FIG. 27B.

In this way, the information about the questions of the collection session transmitted to the server 11 is received by the transceiver 310 of the server 11, and the data registration part 325 may store the received information in the question data file 345, the answer column data file (summarized) 346a, and the answer column data file (detailed) 346b in association with the identifiers such as the question ID and the answer column ID. Identifiers such as the question ID and the answer column ID may be manually assigned by the server administrator individually, and may be automatically allocated according to predetermined rules when the server 11 stores the information about the implementation conditions of the collection session in the question data file 345, the answer column data file (summarized) 346a, and the answer column data file (detailed) 346b.

Further, the information about the questions of the evaluation session transmitted to the server 11 is received by the transceiver 310 of the server 11, and the data registration part 325 may store the received information in the question data file 345 and the evaluation axis data file 344 in association with identifiers such as the question ID, the evaluation axis ID, and the answer column ID. The evaluation axis ID may be manually assigned by the server administrator individually, and may be automatically allocated according to predetermined rules when the server 11 stores the information about the questions of the evaluation session in the question data file 345 and the evaluation axis data file 344.

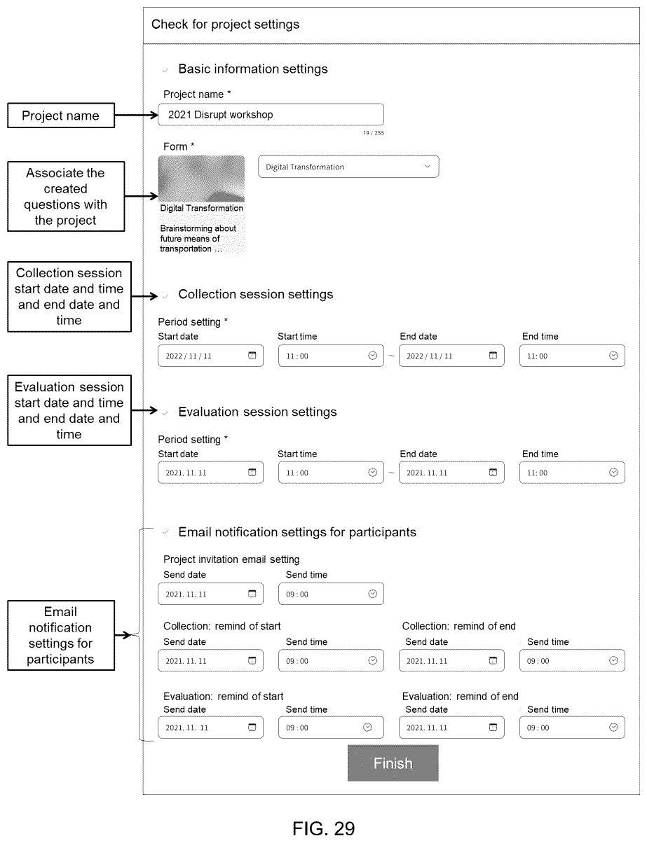

Further, when the project administrator clicks the “Project condition setting” button on the project administrator screen as shown in FIG. 25, the screen switches to a project implementation condition setting screen as shown in FIG. 29. On this screen, the project administrator can input information to be stored in the project data file 343, such as the project name, the start date and time and end date and time of the collection session, the start date and time and end date and time of the evaluation session, and the email notification date and time to the participants. Further, as shown in the figure, a pull-down menu or the like may be provided so that the contents of the collection session and the evaluation session created in advance can be selected from the list of question titles. Alternatively, a brief image of the selected question title and/or a brief description indicating the purpose of the question may be displayed. After the input is completed, the administrator can transmit the information about the implementation conditions of the project to the server 11 by clicking the “Finish” button. In this way, the information about the project implementation conditions transmitted to the server 11 is received by the transceiver 310 of the server 11, and the data registration part 325 can store the received information in the project data file 343 in association with an identifier such as a project ID. The project ID may be manually assigned individually by the server administrator, or may be automatically assigned according to a predetermined rule when the server 11 stores information about the project implementation conditions in the project data file 343.

In addition, the data registration part 325 can register the project administrator. When the server administrator (in other words, the provider of the online evaluation system) logs in using the server administrator terminal 15 according to the above procedure, the server administrator terminal 15 displays a server administrator screen as shown on the left side of FIG. 26. When the server administrator clicks the “Details” button corresponding to the item desired to be set, the server administrator terminal 15 displays a screen for inputting the account information of the project administrator of the organization as shown on the right side of FIG. 26. On the screen, predetermined project administrator account information to be stored in the project administrator account file 353 such as the organization ID, the organization name, the representative name, and the contact information can be input. After completing the input, the administrator account information can be transmitted to the server 11 by clicking the “Save” button. In this way, the administrator account information transmitted to the server 11 is received by the transceiver 310 of the server 11, and the data registration part 325 can store the received information in the project administrator account file 353.

In addition, the data registration part 325 can register the answer data including the information on the predetermined theme transmitted by the answerer in the collection session. For example, when the answerer terminal 12 displays the screen for answerers in the collection session as shown in FIG. 23, if the answerer inputs information in the answer column, which is a kind of information input section, and clicks the “Transmit” button, the answer data from the answerer is transmitted to the server 11 via the computer network 14. The data registration part 325 is capable of performing a step 2C comprising assigning an answer ID to the answer data, and storing the answer data in the answer data files 348a and 348b in association with the answerer ID and the like of the answerer who has transmitted the answer data. Alternatively, it is possible that only when the time limit judgement part 328 judges that the answer data received by the transceiver 310 is within the time limit, the data registration part 325 assigns an answer ID to the answer data, and stores the answer data in the answer data files 348a and 348b in association with the answerer ID and the like of the answerer who has transmitted the answer data.

The number of times the answerer can input the information to be evaluated in the answer column and transmit it may be appropriately set by the project administrator according to the purpose of the collection session. For example, it may be set such that it can be transmitted only once, or it may be set such that it can be transmitted multiple times when the purpose is to collect many kinds of ideas. In addition, it may be possible to collectively transmit the information as a plurality of evaluation targets input in a plurality of answer columns.

In addition, the data registration part 325 can register the evaluation by the evaluator. For example, when the evaluator terminal 12 displays the evaluator screen in the evaluation session as shown in FIG. 22, the evaluator selectively inputs the evaluation for the information displayed in the answer column for each evaluation axis (for example, click one of the buttons showing the empathy of the evaluator: “I don't think so at all (1)”, “I don't think so much (2)”, “Neutral (3)”, “I think so (4)”, “I think so very much (5)”) and clicks the “Transmit” button, and then the evaluation result data from the evaluator is transmitted to the server 11 via the computer network 14. When the transceiver 310 receives the evaluation result data, the data registration part 325 is capable of performing a step 1D comprising assigning an evaluation ID to the evaluation result data and storing the evaluation result data in the evaluation result data file 349 in association with the evaluator ID who has transmitted the evaluation result data and the answer ID. In the evaluation session, as in the collection session, it is possible that only when the time limit judgement part 328 judges that the evaluation result data has been received within the time limit, the evaluation result data are stored in the evaluation result data file 349.

(Information Input Data Extraction Part)

The information input data extraction part is capable of performing a step 2A comprising extracting the question data from the question data file 345 and the answer column data file (summarized) 346a, and extracting the second format data that match the conditions stored in the answer column data files 346a and 346b from the second format data file 362, and transmitting them from the transceiver 310 via the computer network 14 all at once or individually to the answerer terminals 12 of a plurality of answerers flagged as answerers in the collection session in the session participant registration data file 342. The extraction and transmission may be triggered by the transceiver 310 receiving an instruction to start a collection session transmitted from the project administrator terminal 13, and also may be triggered by the transceiver 310 individually receiving a request to start a collection session from an answerer terminal 12. Further, after receiving an instruction or request to start a collection session, the information input data extraction part 324 can change the status in the session participant registration data file 342 or the like to a status indicating that the collection session has started and store the status.

(Time Limit Judgement Part)

The time limit judgement part 328 may, for example, in the collection session (or the evaluation session), use the timer 207 which is built in the server 11 to judge whether or not the time when the transceiver 310 receives the answer data transmitted from the answerer terminal 12 (or the evaluation result data transmitted from the evaluator terminal 12) is within a time limit, based on the time information such as the project ID, the start date and time of the collection session (or evaluation session), the end date and time of the collection session (or evaluation session), the answer (or evaluation) time limit, and the like stored in the project data file 343.

As a result of the judgement, if it is judged that the time limit is met, the time limit judgement part 328 may instruct the data registration part 325 to assign an answer ID (or evaluation ID) to the answer data (or evaluation data), and store them in the answer data file 348a, 348b (or evaluation result data file 349) in association with the answerer ID of the answerer (or evaluator ID of the evaluator) who has transmitted the answer data (or evaluation data).

On the other hand, as a result of the judgement, if it is judged that the time limit has passed, it is possible to refuse the transmission of the answer data from the answerer terminal 12 (or the evaluation data from the evaluator terminal 12) or the reception of them by the server 11. In addition, regardless of whether or not the answer data from the answerer terminal 12 (or the evaluation data from the evaluator terminal 12) is received, if it is judged that a predetermined time limit has passed, the time limit judgement part 328 may inform the end of the collection session (or the evaluation session) from the transceiver 310 in a displayable form to the answerer terminal 12 (or the evaluator terminal 12) and the project administrator terminal 13, and refuse to receive the answer data (or the evaluation data) which fail to meet the time limit. In addition, in order to record that the collection session (or the evaluation session) has ended, the time limit judgement part 328 of the server 11 can change the status in the session participant registration data file 342 or the like to “collection session (or evaluation session) ended”. Furthermore, the time limit judgement part 328 may inform the evaluator allocation part 322 that the collection session has ended.

(Evaluator Allocation Part)

After it is confirmed the collection session is ended when the status in the session participant registration data file 342 and the like becomes “collection session ended” for all the participants of the collection session, or when receiving a notification from the time limit judgement part 328 that the collection session has ended, the evaluator allocation part 322 receives an evaluation session start instruction transmitted from the project administrator terminal 13 by the transceiver 310, and it can perform a step 1A comprising allocating evaluators who should evaluate the information (the answer content) in the answer data stored in the answer data file (detailed) 348b, from among a plurality of evaluators flagged as evaluators for the current evaluation session in the session participant registration data file 342. Alternatively, after it is confirmed the collection session is ended when the status in the session participant registration data file 342 and the like becomes “collection session ended” for all the participants of the collection session, or when receiving a notification from the time limit judgement part 328 that the collection session has ended, the evaluator allocation part 322 may not wait for the evaluation session start instruction transmitted from the project administrator terminal 13, and it can automatically perform a step 1A comprising allocating evaluators who should evaluate the information (the answer content) in the answer data stored in the answer data file (detailed) 348b, from among a plurality of evaluators flagged as evaluators for the current evaluation session in the session participant registration data file 342. This makes it possible to save evaluation time.

When the project administrator prepares a plurality of evaluation targets in advance, and the data related to a plurality of evaluation targets is stored in the storage unit 340 of the server 11, a collection session may not be performed. In that case, when the evaluator allocation part 322 receives the evaluation session start instruction transmitted from the project administrator terminal 13, it may allocate evaluators who should evaluate the data related to the evaluation targets stored in the data storage unit, from among a plurality of evaluators flagged as evaluators for the current evaluation session in the session participant registration data file 342.

The population of the evaluation targets can be appropriately selected by the project administrator, and there are no particular restrictions. The evaluation targets may be limited to the information collected by the current collection session, or other information such as the information collected by a collection session in the past may be added to the evaluation targets. Alternatively, information collected from neither the current nor past collection sessions may be evaluated. In this embodiment, since the evaluator's evaluation ability is calculated independently of the evaluator's idea creativity, the degree of freedom of the evaluation target is high. FIG. 38 shows an example of a screen for selecting a population of evaluation targets (answers in this case) displayed on the project administrator terminal 13. Answers with the “Evaluation target flag” checked can be selected as the evaluation target of the evaluation session.

The method of allocating the evaluators may be conducted according to a predetermined method, and there is no particular limitation. For example, all evaluators may evaluate all the information obtained in the collection session (except for information provided by the evaluator himself/herself) (total evaluation). If there is a lot of information to be evaluated, in order to reduce the evaluation burden of each evaluator, it is possible to obtain a random number generated from the random number generator 206 built in the server 11, and determine the information that each evaluator should evaluate from the population of evaluation targets stored in the evaluation target storage part such as the answer data file (details) 348b using the random number (random shuffle evaluation). When performing random shuffle evaluation, the evaluator allocation part 322 may determine which evaluator evaluates which information by allocating the identifiers of the evaluation targets such as the answer IDs to a number of people required for evaluation from the evaluator IDs using the random number.

From the viewpoint of analyzing the degree of strictness and connoisseurship of the evaluators, it is necessary that one evaluator evaluates a plurality of, preferably 10 or more, and more preferably 20 or more evaluation targets. However, if the number of evaluation targets to be evaluated by one evaluator becomes excessive, the burden on the evaluators will increase. Therefore, from the viewpoint of reducing the burden on the evaluators, the number of evaluation targets evaluated by one evaluator is preferably 100 or less, and more preferably 50 or less.

From the viewpoint of analyzing the evaluation ability score corresponding to the connoisseurship of the evaluators, the number of evaluators for one evaluation target needs to be a plurality, preferably 5 or more, and more preferably 10 or more. There is no particular upper limit to the number of evaluators for one evaluation target, but it is desirable to set the number of evaluation targets evaluated by one evaluator to stay within the above range.

Once the evaluators to evaluate each evaluation target are determined, the evaluator allocation part 322 can store the evaluator ID, the identifier of the evaluation target such as the answer ID to be evaluated, the required number of evaluations, the number of completed evaluations, and the like in association with each other for each evaluator in the evaluation progress management file 355 for managing the progress of evaluation by the evaluators.

An example of procedure for determining the evaluators by the evaluator allocation part 322 will be described. The evaluator allocation part 322 may count the total number of evaluation targets based on, for example, the number of answer IDs in which the information as the evaluation target is stored, and calculate the maximum number of evaluation targets to be allocated to each evaluator using the following formula. The calculation result may be rounded up to an integer.

Maximum allocation number=(total number of evaluation targets)×(number of evaluators for one evaluation target)/(total number of evaluators)

The number of evaluators to evaluate one evaluation target may follow the “number of evaluators allocated to one evaluation target” stored in the project data file 343.

It is preferable that the evaluator allocation part 322 refer to the answer data file (summarized) 348a, and when the answerer ID of the answerer who has transmitted the information as the evaluation target and the evaluator ID of the evaluator who should evaluate the information by this answerer selected by a random number matched, it is preferable to cancel the selection and perform selection again with random numbers. In addition, when a specific evaluation target is selected a number of times exceeding the maximum allocations number obtained above, it is also preferable that the evaluator allocation part 322 cancels the selection and perform selection again with random numbers. If there are enough evaluators, in such a way of selecting evaluators, all evaluators can be allocated with either “Maximum allocation number” or “Maximum allocation number−1” of evaluation targets to be evaluated.

When allocating evaluation targets to evaluators, the order of evaluation targets allocated to evaluators may be randomized such that the order of allocation is different from the generation order (time series) of evaluation targets collected by the collection session. Further, in order to make the order of allocating the evaluation targets to the evaluators uniform for each evaluator, the allocation may be performed in order of increasing such that the evaluator with the smallest number of allocated evaluation target(s) at the time of allocating the evaluation targets is first allocated. Further, after the evaluators to evaluate each evaluation target is determined, the order of presenting the allocated evaluation targets to the evaluators may be randomized. By performing one or more of these procedures, it is possible to prevent bias of the evaluation targets and the evaluators, and it is possible to improve the reliability of the evaluation result.

Further, the evaluator allocation part 322 may be configured to change the status in the session participant registration data file 342 and the like to the status indicating that the evaluation session has started and store it at an appropriate timing such as receiving an evaluation session start instruction transmitted from the project administrator terminal 13.

(Evaluation Input Data Extraction Part)

According to the determination of evaluators to evaluate information by the evaluator allocation part 322, the evaluation input data extraction part 323 is capable of performing a step 1B comprising extracting the data related to the evaluation targets such as the answer data including the information to be evaluated by each evaluator from the evaluation target data storage part such as the answer data file (detailed) 348b, based on the identifier of the evaluation target such as the answer ID and the evaluator ID stored in the evaluation progress management file 355; and extracting the question data including question texts related to predetermined themes in the evaluation session from the question data file 345; and extracting the first format data for evaluation input including the selective evaluation input action based on at least one evaluation axis from the first format data file 361, based on the conditions related to the evaluation axis stored in the evaluation axis data file 344; and transmitting the data related to the evaluation targets such as the answer data, the question data, and the first format data are from the transceiver 310 to the corresponding evaluator terminal 12 via the computer network 14. When transmitting the data related to the evaluation targets such as the answer data, all the data to be evaluated by each evaluator may be transmitted all at once, or may be divided and transmitted.

At this time, the evaluation input data extraction part 323 may extract other information such as evaluation input conditions in the evaluation axis data file 344, question texts related to the predetermined theme in the collection session in the question data file 345, and question texts stored in the answer column data file (summarized) 346a, and transmit them together in a displayable form.

(Evaluation Number Judgement Part)

When the server 11 receives the evaluation result data transmitted from the evaluator terminal 12 at the transceiver 310, the evaluation number judgement part 329 of the server 11 increases the number of completed evaluations by one in the evaluation progress management file 355 in association with the evaluator ID of the evaluator who has transmitted the evaluation. The evaluation number judgement part 329 can grasp the progress of the evaluation session of this evaluator by comparing the number of completed evaluations and the required number of evaluations.

When the data related to the evaluation targets such as the answer data is divided and transmitted to each evaluator, the evaluation number judgement part 329 judges whether or not this evaluator has reached the required number of evaluations according to the above determination. If it is judged that the required number of evaluations has not been reached, the evaluation input data extraction part 323 transmits data related to the evaluation targets such as an unevaluated answer data to the corresponding evaluator terminal 12 together with the first format data in a displayable form from the transceiver 310 via the computer network 14.

When the evaluation number judgement part 329 judges that the number of completed evaluations of a certain evaluator has reached the required number of evaluations, it may transmit the evaluation session end screen and/or the progress information that the evaluation session has ended from the transceiver 310 to the evaluator terminal 12 of the evaluator and the project administrator terminal 13. At this time, in order to record that the evaluation session has ended, the evaluation number judgement part 329 may change the status in the session participant registration data file 342 or the like to “evaluation session ended”.

(Answer Number Judgement Part)

When the server 11 receives the answer data transmitted from the answerer terminal 12 at the transceiver 310, the answer number judgement part 330 of the server 11 increases the number of completed answers by one in the answer progress management file 356 in association with the answerer ID of the answerer who has transmitted the answer data. The answer number judgement part 330 can grasp the progress of the collection session of this answerer by comparing the number of completed answers and the number of required answers.

In cases of dividing the data including information necessary for answer input such as the question data and transmitting it to each answerer, the answer number judgement part 330 judges whether or not the answerer has reached the number of required answers in accordance with the above determination. If it is judged that the required number of answers has not been reached, the information input data extraction part 324 transmits the data including information necessary for answer input, such as an unanswered question data, to the corresponding answerer terminal 12 together with the second format data in a displayable form from the transceiver via the computer network 14.

When answer number judgement part 330 judges that the number of completed answers of a certain answerer has reached the required number of answers, it may transmit a collection session end screen and/or a progress information that the collection session has ended from the transceiver 310 to the answerer terminal 12 of this answerer and the project administrator terminal 13. At this time, in order to record that the collection session has ended, the evaluation number judgement part 334 can change the status in the session participant registration data file 342 or the like to “collection session ended”.

(Evaluation Analysis Part)

### First Embodiment

### (1) Analysis of Degree of Strictness of Evaluator and Correction of Evaluation (Step 1E)

The evaluation analysis part 326 is capable of analyzing the degree of strictness of the evaluation of each evaluator for each evaluation axis based on the evaluation input by each evaluator in the selective evaluation input section in the evaluation result data file 349. As a result of the analysis, the evaluation analysis part 326 corrects the evaluation such that the evaluation by the evaluator who gives a strict evaluation rises relatively and the evaluation by the evaluator who gives a lax evaluation decreases relatively, thereby calculating a corrected evaluation.

Among the evaluators, there are those who give a lax evaluation and those who give a strict evaluation, and the evaluation tendency differs depending on the evaluators. For this reason, if there are many evaluators who give excessive evaluations, there is a possibility that the evaluation results will differ greatly even for the same evaluation target depending on which evaluator gives evaluation. Therefore, by adjusting the degree of strictness of the evaluation that may differ for each evaluator, it is possible to reduce the influence of the evaluators who give excessive evaluations.

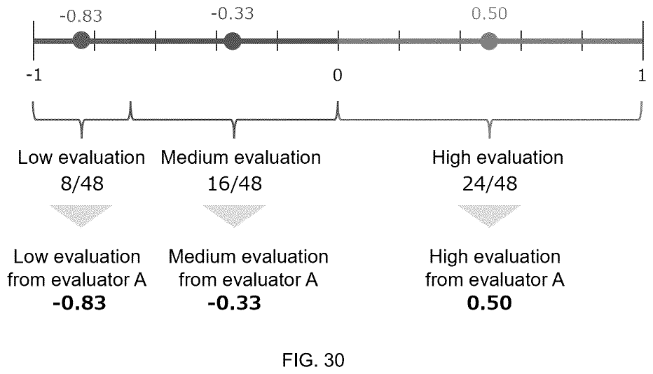

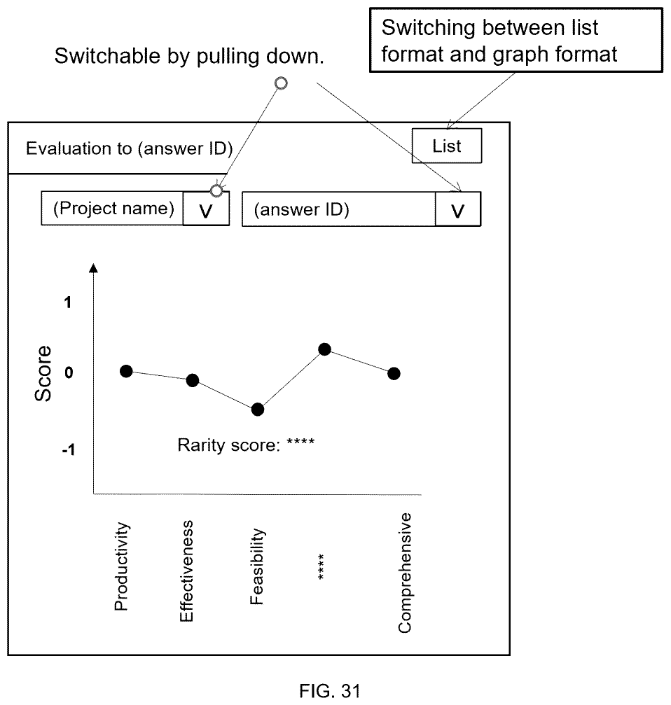

The method of adjusting the strictness is not particularly limited as long as the evaluation is corrected such that the evaluation by the evaluator who gives a strict evaluation rises relatively and the evaluation by the evaluator who gives a lax evaluation decreases relatively, and a specific method for adjusting the strictness will be described for illustration. For example, assuming a result of evaluating 48 evaluation targets (for example, business ideas) by an evaluator A in 3 grades according to a given evaluation axis is as follows:
the number of low evaluation (evaluation value=−1): 8,
the number of medium evaluation (evaluation value=0): 16, and
the number of high evaluation (evaluation value=+1): 24.
   According to the ratio of low evaluations, medium evaluations, and high evaluations of the evaluator A, low evaluations, medium evaluations, and high evaluations are distributed in this order on a number line from −1 to +1 (numerical range is 2) (FIG. 30). Since the number of low evaluations is 8 out of 48, 16.7% of the total evaluations are low evaluations. 16.7% corresponds to a width of 0.334 based on the numerical width 2. On the number line, a width of 0.334 from −1 to −0.666 is allocated as the low evaluation region. Since the midpoint in the low evaluation region is −0.83, the value at this midpoint is used as the corrected evaluation value when the evaluator A gives a low evaluation. Similarly, when the corrected evaluation values are calculated for the medium evaluation and the high evaluation in the same manner, they are −0.33 and +0.50, respectively. The evaluation value is an index of the degree of influence that the evaluation by the evaluator has on the score on the evaluation target.

When the degree of strictness is adjusted by the above method, if an Evaluator B is a lax evaluator and all 48 evaluation targets are given a high evaluation (evaluation value=+1), the evaluation value of the high evaluation by the Evaluator B is 0 point. Further, if an Evaluator C is a strict evaluator and all 48 evaluation targets are given a low evaluation (evaluation value=−1), the evaluation value of the low evaluation by the Evaluator C is also 0 point.

The evaluation analysis part 326 may store the corrected evaluation value in the evaluation result data file 349 in association with the evaluator ID of each evaluator and the identifier of the evaluation target (example: the answer ID). The corrected evaluation value may be stored in a temporary file, and the temporary file for temporarily storing the corrected evaluation value is also a kind of evaluation result data storage part.

### (2) Calculation of Provisional Score of Evaluation Targets (Step 1F)

The evaluation analysis part 326 is capable of aggregating the evaluations of each evaluation target based on the corrected evaluation and the identifier of the evaluation target (example: the answer ID) stored in the evaluation result data file 349 to calculate a provisional score of each evaluation axis for each evaluation target. Then, the evaluation analysis part 326 may store the provisional score in the evaluation target score data storage unit (example: the answer score data file 351) in association with the identifier of each evaluation target (example: the answer ID).

An example of a calculation method of the provisional score is shown below. For example, let us assume four evaluators (A, B, C, D) evaluated an idea. Table 1 shows the evaluation values by each evaluator for the idea and the evaluation values after correction by analyzing the degree of strictness according to the above-mentioned method. In this case, the provisional score of this idea can be calculated as (0.56+0.12−0.54+0.70)/4=0.21 assuming that the evaluation ability of all the evaluators is the same. At this stage, the evaluative ability of the evaluators is unknown, so it is appropriate to consider the evaluative ability of the evaluators to be the same.

TABLE 1

| | Evaluator A | Evaluator B | Evaluator C | Evaluator D |
|---|---|---|---|---|
| Evaluation | High | Medium | Low | High |
| | evaluation | evaluation | evaluation | evaluation |
| | (◯) | (Δ) | (X) | (◯) |
| Corrected | 0.56 | 0.12 | −0.54 | 0.7 |
| evaluation | | | | |
| Provisional | 0.21 | | | |
| score | | | | |

### (3) Calculation of Evaluation Ability Score of Evaluators (Step 1G)

The evaluation analysis part 326 is capable of comparing for each evaluation axis the corrected evaluation of each evaluation target associated with the evaluator ID stored in the evaluation result data file 349 with the provisional score of each evaluation target stored in the evaluation target score data storage part (example: the answer score data file 351), and by aggregating the closeness between the them for each evaluator to calculate the evaluation ability score of each evaluator. Then, the evaluation analysis part 326 may store the evaluation ability score in the evaluator score data file 350 in association with the evaluator ID of each evaluator.

Any statistical method may be used for the method of aggregating the closeness between the corrected evaluation and the provisional score, and there are no particular restrictions. For example, there is a method of calculating the correlation coefficient between them, Pearson's product-moment correlation coefficient, Euclidean distance, cosine similarity, and polyserial correlation coefficient. For illustration, a method of calculating the correlation coefficient between the corrected evaluation and the provisional score will be described. Table 2 shows the provisional scores for eight ideas from Idea 1 to Idea 8, the evaluation given by Evaluator A for each idea, and the corrected evaluation value by analyzing the degree of strictness of Evaluator A. The correlation coefficient between the “Provisional score” and the “Corrected evaluation value” calculated from Table 2 is 0.60. It can be said that the higher the correlation coefficient between the them is, the higher the closeness between them, and a higher evaluation ability score can be acquired. By comparing the closeness among the evaluators participating in the evaluation session, it is possible to perform a relative rating of the evaluation ability among the evaluators.

TABLE 2

| | Provisional | Evaluation by | Corrected |
|---|---|---|---|
| | score | Evaluator A | evaluation value |
| Idea 1 | 0.92 | High evaluation | 0.50 |
| | | (◯) | |
| Idea 2 | 0.91 | Medium evaluation | −0.33 |
| | | (Δ) | |
| Idea 3 | 0.88 | Low evaluation | −0.83 |
| | | (X) | |
| Idea 4 | 0.84 | High evaluation | 0.50 |
| | | (◯) | |
| Idea 5 | 0.5 | Medium evaluation | −0.33 |
| | | (Δ) | |
| Idea 6 | 0.2 | Medium evaluation | −0.33 |
| | | (Δ) | |
| Idea 7 | −0.1 | Low evaluation | −0.83 |
| | | (X) | |
| Idea 8 | −0.3 | Low evaluation | −0.83 |
| | | (X) | |

Correlation coefficient 0.6

The evaluation ability score may be an index that can relatively rate the evaluation ability among evaluators, and there is no particular limitation on the expression method. For example, the above-mentioned correlation coefficient itself may be used as the evaluation ability score. Further, a parameter derived from the correlation coefficient based on a predetermined standard may be used as the evaluation ability score. For example, evaluators may be rated in descending order of correlation coefficient, and evaluation ability scores may be given according to predetermined criteria.

An example of a method of rating evaluators in descending order of correlation coefficient and weighting the evaluations will be described. Assuming that the total number of evaluators is N for each evaluation axis, the evaluation analysis part 326 gives weighting to the evaluations by the evaluators in the k rank (k=1 to N) regarding the evaluation ability according to the following formula.

Weight=1+sin{(1−2×(k−1)/(N−1))×pi/2}

By weighting in this way, a weighting coefficient (weight) can be assigned to each evaluator for each evaluation axis. The weighting coefficient may be adopted as the evaluation ability. In this case, the evaluation by each evaluator had the voting value of one vote equally initially, but the evaluation by the highest evaluator changes to have a voting value of two votes, and the evaluation by the lowest evaluator changes to have a voting value of 0 votes.

### (4) Calculation of Corrected Score of Evaluation Targets (Step 1 H)

The above-mentioned provisional score was calculated under the assumption that all evaluators have the same evaluative ability because the evaluators' evaluation ability was unknown. However, in order to give an appropriate evaluation to the evaluation target, it is appropriate to give a greater weighting to the evaluations from the evaluators with higher connoisseurship.

Therefore, the evaluation analysis part 326 can calculate a corrected score of each evaluation target for each evaluation axis by aggregating the evaluations of each evaluation target based on the corrected evaluation, the evaluator ID of the evaluators and the identifier of the evaluation target (example: the answer ID) stored in the evaluation result data file 349, and the evaluation ability score of each evaluator stored in the evaluator score data file 350, on condition that a greater weighting is given to the evaluation by the evaluator with a higher evaluation ability score. Then, the evaluation analysis part 326 can store the corrected score in the evaluation target score data storage part (example: the answer score data file 351) in association with the identifier of each evaluation target (example: the answer ID).

The specific calculation method of the corrected score may be appropriately determined so as to satisfy the above condition. An example of how to calculate the corrected score is shown below. For example, let us assume four evaluators (A, B, C, D) evaluated an idea. Table 3 shows the evaluation by each evaluator for the idea, the corrected evaluation value by analyzing the degree of strictness according to the above-mentioned method, and the evaluation ability score of each evaluator. In this case, the provisional score of the idea is 0.21 as described above. On the other hand, as a method of calculating the corrected score, when a method of giving weighting by weighted-averaging the corrected evaluations by the evaluators with the evaluation ability score of each evaluator is adopted, the corrected score of the idea becomes 0.29. A value after further performing arbitrary statistical processing on this value may be defined as the corrected score.

TABLE 3

| | Evaluator A | Evaluator B | Evaluator C | Evaluator D |
|---|---|---|---|---|
| Evaluation | High | Medium | Low | High |
| | evaluation | evaluation | evaluation | evaluation |
| | (◯) | (Δ) | (X) | (◯) |
| Corrected | 0.56 | 0.12 | −0.54 | 0.7 |
| evaluation | | | | |
| Evaluation | 0.6 | 0.7 | 0.3 | 0.5 |
| ability score | | | | |
| Provisional | 0.21 | | | |
| score | | | | |
| Corrected | 0.29 | | | |
| score | | | | |

### (5) Repetition of Steps 1G and 1H

The corrected score obtained in the above procedure or the statistic calculated based on the corrected score may be used as the final score of the evaluation target. Alternatively, the evaluation analysis part 326 may regard the corrected score of each evaluation target as the provisional score and repeat the step 1G and the step 1 H one or more times. By repeating the calculation of the evaluation ability score of the evaluator (step 1G) and the calculation of the score of the evaluation target by giving weighting to the evaluation based on the evaluator's evaluation ability (step 1H) once or more, preferably 10 times or more, more preferably 100 times or more, it is possible to obtain a calculation result with higher consistency between the evaluation ability score of each evaluator and the score of each evaluation target, which are mutually reflected in the calculation.

It is desirable that steps 1G and 1H are repeated until either or both of the evaluation ability score and the corrected score of each evaluation target converge. This is because by repeating the step 1G and the step 1H until either, preferably both, of the evaluation ability score and the corrected score of each evaluation target converge, there is an advantage is that the calculated score reaches a solution with the maximum explanatory power and consistency. However, the evaluation ability score or the corrected score of each evaluation target may not converge even if the steps 1G and 1H are repeated (these may diverge, or may converge in a periodic manner, or the like). Therefore, a maximum number of repetition (for example, a value in the range of 10 to 100 times) may be set in advance, and if neither the evaluation ability score nor the corrected score of each evaluation target converges by then, the final evaluation ability score and the corrected score may be determined based on the calculation results obtained by repeating the maximum number. In addition, if either or both of the evaluation ability score and the corrected score of each evaluation target converge before reaching the predetermined maximum number of repetition, the step 1G may not be repeated any more in order to shorten the calculation time.

Therefore, in one embodiment, when either or both of the following conditions (a) and (b) are satisfied, the evaluation analysis part 326 may stop repeating the step 1G even if the maximum number of repetition set in advance is not reached. Therefore, the evaluation analysis part 326 performs a final step 1H after a final step 1G, so that the repetition of the step 1G and the step 1H is completed.
(a) each time the step 1G is repeated, a difference or rate of change for each evaluation axis between a latest evaluation ability score and a previous evaluation ability score of each evaluator is calculated, and when judging whether or not the difference or rate of change satisfies a preset condition for each evaluator, the preset condition is satisfied for all the evaluators;
(b) each time the step 1H is repeated, a difference or rate of change for each evaluation axis between a latest corrected score and a previous corrected score of each evaluation target is calculated, and when judging whether or not the difference or rate of change satisfies a preset condition for each evaluation target, the preset condition is satisfied for all the evaluation targets.

If the evaluation ability score does not converge, the evaluation ability score to be finally adopted does not need to be the latest evaluation ability score after being repeated a predetermined number of repetition. The average value of several evaluation ability scores (for example, the evaluation ability scores calculated in the last few times, for example, the last 2 to 6 times) may be adopted as the final evaluation ability score. Similarly, if the corrected score does not converge, the corrected score to be finally adopted does not need to be the latest corrected score after being repeated a predetermined number of repetition. The average value of several corrected scores (for example, the corrected scores calculated in the last few times, for example, the last 2 to 6 times) may be adopted as the final corrected score.

### (6) Calculation of Rarity Score of Evaluation Targets (Step 1J)

The evaluation target data storage part (example: the answer score data file 351) may also store data related to a plurality of evaluation targets different from the plurality of evaluation targets used in the current evaluation session. The data related to a plurality of evaluation targets different from the plurality of evaluation targets used in the current evaluation session include, for example, the answer data collected by collection sessions in the past, the data on evaluation targets separately prepared by the project administrator, and the like.

In this case, the evaluation analysis part 326 can calculate the rarity score of each evaluation target in the current evaluation session, by calculating similarity between each of the plurality of evaluation targets in the current evaluation session and the other evaluation targets used in the current evaluation session and/or the different evaluation targets, and aggregating the calculated similarity, Then, it may store the rarity score in the evaluation target score data storage part (example: the answer score data file 351) in association with the identifier of each evaluation target (example: the answer ID).

The similarity between the evaluation targets may be calculated by a known method according to the format of the evaluation targets. For example, when the evaluation target is expressed in the form of a multiple-choice type such as numerical values or options, a method using a correlation coefficient can be mentioned. When the evaluation target is expressed in a text format using a language, there is a method of calculating the similarity between the evaluation targets by performing context analysis such as parsing and semantic analysis by natural language processing for each evaluation target. As a method of natural language processing, there is a method in which the evaluation target (text data) is morphologically analyzed, decomposed into words, each word is vectorized (distributed expression), and the evaluation target is vectorized by using a technique such as LSTM or Average Pooling. When the evaluation targets are vectorized, the similarity between the evaluation targets is calculated based on the Euclidean distance and/or the cosine similarity. The similarity is represented by 0 (same) to ∞ (totally different) for the Euclidean distance and 1 (same) to −1 (opposite) for the cosine similarity.

For example, if the evaluation target is a business idea, N business ideas (N can be, for example, 5 to 20) similar to the business idea are searched for in the evaluation target data storage part in descending order of similarity, and the average value of the inverse number of the similarity of found business ideas of high similarity may be used as the rarity score.

### (7) Calculation of Answerer Scores (Step 2D)

In one embodiment, the evaluation analysis part 326 is capable of performing a step 2D comprising calculating a score of the answerer for at least one evaluation axis, based on data related to the evaluation targets including the corrected score itself of each evaluation target for each evaluation axis and/or a statistic calculated based on the corrected score, and the identifier of the answerer stored in the evaluation target score data storage part (example: the answer score data file 351), and storing the score of the answerer in the answerer score data storage part (example: the answerer score data file 352).

### Second Embodiment

In the second embodiment, as in the first embodiment, after the degree of strictness of the evaluators is analyzed and the evaluation is corrected (step 1F), the score of the evaluation target and the evaluation ability are calculated. However, the method of data processing after step 1F is different from that of the first embodiment. In the first embodiment, the evaluation ability of an evaluator is calculated by taking into account the evaluation results for the evaluation target by the evaluator himself/herself who should be calculated the evaluation ability, and the score of the evaluation target is calculated based on the evaluation ability of each evaluator calculated in this way. Although this method has an advantage that data processing can be performed in a short time, it causes noise because the evaluation result by the evaluator himself/herself who should be calculated the evaluation ability is considered. That is, when the evaluation result by the evaluator himself/herself who should be calculated the evaluation ability is taken into consideration, the evaluation ability of the evaluator is calculated higher. Therefore, by calculating the evaluation ability of the evaluator based on the evaluation results by evaluators other than the evaluator himself/herself who should be calculated the evaluation ability, more reliable results can be obtained (because it is possible to prevent the evaluator who has first acquired a high evaluation ability from becoming higher in the evaluation ability each time the evaluation is repeated).

For example, let us assume four evaluators (A, B, C, D) evaluated a certain evaluation target, and only the Evaluator A gave a low evaluation (X) (a cross) and the remaining three gave a high evaluation (◯) (a circle). It can be understood that when calculating the evaluation ability of the Evaluator A, rather than considering the evaluation result by the Evaluator A, calculating the evaluation ability of the evaluator A based on the evaluation results by only the remaining three people will lower the evaluation ability of the evaluator A, and it can be understood this is a more reliable result. Hereinafter, a specific example of data processing according to the second embodiment will be described.

(1) Analysis of Degree of Strictness of Evaluator and Correction of Evaluation (Step 1 E)

Since the step 1E in the second embodiment is the same as that in the first embodiment, the description thereof will be omitted.

(2) Calculation of Provisional Score of Evaluation Targets (Step 1F)

Assuming that the number of the evaluators is n (n is an integer of 2 or more), the evaluation analysis part 326 is capable of performing a step comprising, for each of the first to n^{th} evaluator, without considering the evaluation of the evaluation target by the k^{th} evaluator (k is an integer from 1 to n), aggregating the evaluations of each evaluation target based on the corrected evaluation by the evaluators other than the k^{th} evaluator and the identifier of the evaluation target stored in the evaluation result data storage part to calculate a provisional score of each evaluation target for each evaluation axis. Then, the evaluation analysis part 326 is capable of performing a step comprising, for each of the first to n^{th} evaluator, storing the provisional score in the evaluation target score data storage part (example: the answer score data file 351) in association with the evaluator ID of the k^{th} evaluator and the identifier of each evaluation target (example: the answer ID).

An example of the calculation method of the provisional score is shown below. For example, let us assume four evaluators (A, B, C, D) evaluated an idea. The evaluation value of the idea by each evaluator and the corrected evaluation value obtained by analyzing the degree of strictness according to the above-mentioned method are as shown in Table 1 described above. Assuming evaluation ability of all evaluators is the same, then the provisional score of the idea for calculating the evaluation ability of Evaluator A is calculated as (0.12−0.54+0.70)/3=0.09 with the evaluation result by the Evaluator A excluded. A provisional score can be calculated for the Evaluators B to D in the same manner. The results are shown in Table 4. It can be seen that a large difference occurs when the provisional score is calculated excluding the evaluation by the evaluator himself/herself. At this stage, the evaluative ability of the evaluators is unknown, so it is appropriate to consider the evaluative ability of the evaluators to be the same.

TABLE 4

| | Evaluator A | Evaluator B | Evaluator C | Evaluator D |
|---|---|---|---|---|
| Evaluation | High | Medium | Low | High |
| | evaluation | evaluation | evaluation | evaluation |
| | (◯) | (Δ) | (X) | (◯) |
| Corrected | 0.56 | 0.12 | −0.54 | 0.7 |
| evaluation | | | | |
| Provisional | 0.09 | 0.24 | 0.46 | 0.05 |
| score | | | | |

(3) Calculation of Provisional Evaluation Ability Score of Evaluators (Step 1G₁)

Next, the provisional evaluation ability of the evaluators is calculated. The reason for calling it “provisional evaluation ability” is that the evaluation ability calculated in the step 1G₁ is not the final evaluation ability. Specifically, the evaluation analysis part 326 is capable of comparing for each evaluation axis the corrected evaluation of each evaluation target associated with the evaluator ID of the k^{th} (k is an integer from 1 to n) evaluator stored in the evaluation result data storage file 349 with the provisional score of each evaluation target stored in the evaluation target score data storage part (example: the answer score data file 351) associated with the evaluator ID of the k^{th} evaluator and the identifier of each evaluation target (example: the answer ID), and aggregating closeness between the them for each evaluator to calculate a provisional evaluation ability score of the k^{th} evaluator. Then, the evaluation analysis part 326 is capable of performing a step, for each of the first to n^{th} evaluator, comprising storing the provisional evaluation ability score in the evaluator score data file 350 in association with the evaluator ID of the k^{th} evaluator.

Any statistical method may be used for the method of aggregating the closeness between the corrected evaluation and the provisional score, and there are no particular restrictions. For example, there is a method of calculating the correlation coefficient, Pearson's product-moment correlation coefficient, Euclidean distance, cosine similarity, and polyserial correlation coefficient between the two. The specific aggregation method is as illustrated in the first embodiment. However, the second embodiment is different from the first embodiment in that the provisional score of each evaluation target for calculating the evaluation ability is different for each evaluator.

Further, the provisional evaluation ability score may be an index that can relatively rate the provisional evaluation ability among evaluators, and the expression method thereof is not particularly limited. The specific expression method is as illustrated in the first embodiment.

(4) Calculation of Corrected Score of Evaluation Targets (Step 1H₁)

The above-mentioned provisional score is calculated under the assumption that all evaluators have the same evaluative ability because the evaluative ability of evaluators is unknown. However, in order to give an appropriate evaluation to the evaluation target, it is appropriate to give a greater weighting to the evaluations by the evaluators with higher connoisseurship. However, since the corrected score will be used to calculate the final evaluation ability of the evaluator in the next step, the corrected score is calculated based on the evaluation results from other evaluators excluding the evaluator who should be calculated the final evaluation ability. Therefore, the second embodiment is different from the first embodiment in that the corrected score of each evaluation target is different for each evaluator.

Specifically, the evaluation analysis part 326 is capable of performing a step comprising, for each of the first to n^{th} evaluator, without considering the evaluation of the evaluation target by the k^{th} evaluator (k is an integer from 1 to n), aggregating the evaluations of each evaluation target based on the corrected evaluation by the evaluators other than the k^{th} evaluator, the evaluator ID of the evaluators and the identifier of the evaluation target (example: answer ID) stored in the evaluation result data storage file 349, and the provisional evaluation ability score of the evaluators other than the k^{th} evaluator stored in the evaluator score data file 350 to calculate a corrected score of each evaluation target for each evaluation axis, on condition that a greater weighting is given to the evaluation by the evaluator with a higher a provisional evaluation ability score. Then, the evaluation analysis part 326 is capable of performing a step comprising, for each of the first to n^{th} evaluator, storing the corrected score in the evaluation target score data storage part (example: the answer score data file 351) in association with the evaluator ID of the k^{th} evaluator and the identifier of each evaluation target (example: the answer ID).

The specific calculation method of the corrected score may be appropriately determined so as to satisfy the above conditions. An example of how to calculate the corrected score is shown below. For example, let us assume four evaluators (A, B, C, D) evaluated an idea. Table 5 shows the evaluation of the idea by each evaluator, the corrected evaluation value obtained by analyzing the degree of strictness according to the above-mentioned method, the provisional score of the idea, and the provisional evaluation ability score of each evaluator. As a method of calculating the corrected score, when a method of giving weighting by weighted-averaging the corrected evaluations by the evaluators with the provisional evaluation ability score of each evaluator is adopted, the corrected score of the idea becomes as shown in the Table 5. A value after further performing arbitrary statistical processing on this value may be defined as the corrected score.

TABLE 5

| | Evaluator A | Evaluator B | Evaluator C | Evaluator D |
|---|---|---|---|---|
| Evaluation | High | Medium | Low | High |
| | evaluation | evaluation | evaluation | evaluation |
| | (◯) | (Δ) | (X) | (◯) |
| Corrected | 0.56 | 0.12 | −0.54 | 0.7 |
| evaluation | | | | |
| Provisional | 0.09 | 0.24 | 0.46 | 0.05 |
| score | | | | |
| Provisional | 0.5 | 0.6 | 0.1 | 0.4 |
| evaluation | | | | |
| ability score | | | | |
| Corrected | 0.27 | 0.51 | 0.42 | 0.25 |
| score | | | | |

(5) Calculation of Final Evaluation Ability Score of Evaluators (Step 1G₂)

Next, the evaluation analysis part 326 calculates the final evaluation ability score of each evaluator based on the corrected score. Specifically, the evaluation analysis part 326 is capable of performing a step 1G₂ comprising, for each of the first to n^{th} evaluator, comparing for each evaluation axis the corrected evaluation of each evaluation target associated with the evaluator ID of the k^{th} (k is an integer from 1 to n) evaluator stored in the evaluation result data file 349 with the corrected score of each evaluation target stored in the evaluation target score data storage part (example: the answer score data file 351) associated with the evaluator ID of the k^{th} evaluator and the identifier of each evaluation target (example: the answer ID), aggregating closeness between them for each evaluator to calculate a final evaluation ability score of the k^{th} evaluator, and storing the final evaluation ability score in the evaluator score data storage part in association with the identifier of the k^{th} evaluator.

Any statistical method may be used for the method of aggregating the closeness between the corrected evaluation and the corrected score, and there are no particular restrictions. For example, there is a method of calculating the correlation coefficient, Pearson's product-moment correlation coefficient, Euclidean distance, cosine similarity, and polyserial correlation coefficient between the two. The specific aggregation method is as illustrated in the first embodiment. However, the second embodiment is different from the first embodiment in that the corrected score of each evaluation target for calculating the final evaluation ability is different for each evaluator.

Further, the final evaluation ability score may be an index that can relatively rate the final evaluation ability among evaluators, and there is no particular limitation on the expression method. The specific expression method is as illustrated in the first embodiment.

(6) Calculation of Final Score of Evaluation Targets (Step 1 H₂)

Next, the evaluation analysis part 326 calculates the final score of the evaluation target by using the final evaluation ability score of each evaluator. When calculating the corrected score, the final evaluation ability score of each evaluator is not determined, so the corrected score of each evaluation target is calculated for each evaluator. On the other hand, when calculating the final score, since the final evaluation ability score of each evaluator has already been determined, by aggregating the evaluations of each evaluation target based on the final evaluation ability score of each evaluator, a single final score of each evaluation target for each evaluation axis can be calculated.

Specifically, the evaluation analysis part 326 can calculate a final score of each evaluation target for each evaluation axis by aggregating the evaluations of each evaluation target based on the corrected evaluation, the evaluator ID of the evaluator and the identifier of the evaluation target (example: the answer ID) stored in the evaluation result data file 349, and the final evaluation ability score of each evaluator stored in the evaluator score data file 350, on condition that a greater weighting is given to the evaluation by the evaluator with a higher final evaluation ability score. Then, the evaluation analysis part 326 can store the final score in the evaluation target score data storage part (example: the answer score data file 351) in association with the identifier of each evaluation target (example: the answer ID).

The specific calculation method of the final score may be appropriately determined so as to satisfy the above conditions. An example of how to calculate the final score is shown below. For example, let us assume four evaluators (A, B, C, D) evaluated an idea. Table 6 shows the evaluation of the idea by each evaluator, the corrected evaluation value obtained by analyzing the degree of strictness according to the above-mentioned method, and the final evaluation ability score of each evaluator. As a method of calculating the final score, when a method of giving weighting by weighted-averaging the corrected evaluations by the evaluators with the final evaluation ability score of each evaluator is adopted, the final score of the idea is as shown in the Table 6. A value after further performing arbitrary statistical processing on this value may be defined as the final score.

TABLE 6

| | Evaluator A | Evaluator B | Evaluator C | Evaluator D |
|---|---|---|---|---|
| Evaluation | High | Medium | Low | High |
| | evaluation | evaluation | evaluation | evaluation |
| | (◯) | (Δ) | (X) | (◯) |
| Corrected | 0.56 | 0.12 | −0.54 | 0.7 |
| evaluation | | | | |
| Final | 0.7 | 0.5 | 0 | 0.5 |
| evaluation | | | | |
| ability score | | | | |
| Final score | 0.47 | | | |

(7) Repeating of Steps 1G₁ and 1H₁

The final score obtained by the above procedure is obtained after performing the step 1G₁ and the step 1H₁ once. Alternatively, the evaluation analysis part 326 may regard the corrected score of each evaluation target as the provisional score, and repeat the step 1G₁ and the step 1 H₁ one or more times. By repeating the calculation of the provisional evaluation ability score of evaluator (step 1G₁) and the calculation of the corrected score of evaluation target by giving weighting to the evaluation based on the provisional evaluation ability of the evaluator (step 1 H₁) once or more, preferably 10 times or more, more preferably 100 times or more, it is possible to obtain a calculation result with higher consistency between the evaluation ability score of each evaluator and the score of each evaluation target, which are mutually reflected in the calculation.

It is desirable that steps 1G₁ and 1H₁ be repeated until either or both of the provisional evaluation ability score and the corrected score of each evaluation target converge. This is because by repeating the step 1G₁ and the step 1H₁ until either, preferably both, of the provisional evaluation ability score and the corrected score of each evaluation target converge, there is an advantage is that the calculated score reaches a solution with the maximum explanatory power and consistency. However, the provisional evaluation ability score or the corrected score of each evaluation target may not converge even if the steps 1G₁ and 1H₁ are repeated (these may diverge, or may converge in a periodic manner, or the like). Therefore, a maximum number of repetition (for example, a value in the range of 10 to 100 times) may be set in advance, and if neither the provisional evaluation ability score nor the corrected score of each evaluation target converges by then, the final evaluation ability score and the final score may be determined based on the calculation results obtained by repeating the maximum number. In addition, if either or both of the provisional evaluation ability score and the corrected score of each evaluation target converge before reaching the predetermined maximum number of repetition, the step 1G₁ may not be repeated any more in order to shorten the calculation time.

Therefore, in one embodiment, when either or both of the following conditions (a) and (b) are satisfied, the evaluation analysis part 326 may stop repeating the step 1G₁ even if the maximum number of repetition set in advance is not reached. Therefore, the evaluation analysis part 326 performs a final step 1 H₁ after a final step 1G₁, so that the repetition of the step 1G₁ and the step 1H₁ is completed.
(a) each time the step 1G₁ is repeated, a difference or rate of change for each evaluation axis between a latest provisional evaluation ability score and a previous provisional evaluation ability score of each evaluator is calculated, and when judging whether or not the difference or rate of change satisfies a preset condition for each evaluator, the preset condition is satisfied for all the evaluators;
(b) each time the step 1 H₁ is repeated, a difference or rate of change for each evaluation axis between a latest corrected score and a previous corrected score of each evaluation target is calculated, and when judging whether or not the difference or rate of change satisfies a preset condition for each evaluation target, the preset condition is satisfied for all the evaluation targets.

Further, if the provisional evaluation ability score does not converge, the provisional evaluation ability score to be finally adopted does not need to be the latest provisional evaluation ability score after being repeated a predetermined number of repetition. The average value of several provisional evaluation ability scores (for example, the provisional evaluation ability scores calculated in the last few times, for example, the last 2 to 6 times) may be adopted as the final provisional evaluation ability score. Similarly, if the corrected score does not converge, the corrected score to be finally adopted does not need to be the latest corrected score after being repeated a predetermined number of repetition. The average value of several corrected scores (for example, the corrected scores calculated in the last few times, for example, the last 2 to 6 times) may be adopted as the final corrected score.

The evaluation analysis part 326 uses the obtained final provisional evaluation ability score to perform the final step 1H₁ to calculate the final corrected score, and after that, by performing the step 1G₂ and the step 1H₂, the final evaluation ability score of the evaluator and the final score of the evaluation target are calculated.

(8) Calculation of Rarity Score of Evaluation Targets (Step 1J)

The evaluation target data storage part (example: the answer score data file 351) may also store data related to a plurality of different evaluation targets from the plurality of evaluation targets used in the current evaluation session. Data related to a plurality of different evaluation targets from the plurality of evaluation targets used in the current evaluation session include, for example, answer data collected by collection sessions in the past, data on evaluation targets separately prepared by the project administrator, and the like.

In this case, the evaluation analysis part 326 can calculate the rarity score of each evaluation target in the current evaluation session, by calculating similarity between each of the plurality of evaluation targets in the current evaluation session and the other evaluation targets used in the current evaluation session and/or the different evaluation targets, and aggregating the similarity. Then, it may store the rarity score in the evaluation target score data storage part (example: the answer score data file 351) in association with the identifier of each evaluation target (example: the answer ID). Since a specific example of the method of calculating the similarity between evaluation targets is the same as that of the first embodiment, the description thereof will be omitted.

(9) Calculation of Answerer Scores (Step 2D)

In one embodiment, the evaluation analysis part 326 is capable of performing a step 2D comprising calculating a score of the answerer for at least one evaluation axis, based on data related to the evaluation targets including the final score itself of each evaluation target for each evaluation axis and/or a statistic calculated based on the final score stored in the evaluation target score data storage part (example: the answer score data file 351), and the identifier of the answerer, and storing the score of the answerer in the answerer score data storage part (example: the answerer score data file 352).

(Evaluation Analysis Data Extraction Part)

The evaluation analysis data extraction part 327 is capable of extracting various evaluation analysis data stored in the evaluation result data file 349, the answerer score data file 352, the evaluator score data file 350, and the evaluation target score data storage part (example: answerer score data file 351), and transmitting the evaluation analysis data from the transceiver 310 to the project administrator terminal 13 in a displayable form via the computer network 14. For example, the evaluation analysis data extraction part 327 is capable of performing a step 1I comprising extracting either or both of the following data (1) and (2), and transmitting them from the transceiver 310 to the administrator terminal 13 via the network:
(1) data related to the evaluation targets, including the corrected score itself of each evaluation target for each evaluation axis and/or a statistic calculated based on the corrected score stored in the evaluation target score data storage part (example: the answer score data file 351).
(2) data related to the evaluator, including the evaluation ability score itself of each evaluator and/or a statistic calculated based on the final evaluation ability score stored in the evaluator score data file 350.

Further, the evaluation analysis data extraction part 327 is capable of performing a step 1K comprising extracting data related the evaluation target, including the rarity score itself of each evaluation target and/or a statistic calculated based on the rarity score stored in the evaluation target score data storage part (example: the answer score data file 351), and transmitting them from the transceiver 310 to the administrator terminal 13 via the network.

Further, the evaluation analysis data extraction part 327 is capable of performing a step 2E comprising transmitting data related to the answerer, including the score itself of each answerer for each evaluation axis and/or a statistic calculated based on the score stored in the answerer score data file 352, from the transceiver 310 to the administrator terminal 13 via the network.

The statistic includes, for example, an arithmetic mean value, a total value, a coefficient of variation, a rank, a standard deviation, and the like, but is not limited thereto.

FIG. 31 shows an example of data related to the evaluation targets displayed on the project administrator terminal 13. In FIG. 31, the score of a specific answer ID for each evaluation axis is shown in a graph format. By clicking “Project name” in FIG. 31, a pull-down menu is displayed, so that a desired project can be selected. Further, by clicking the “Answer ID”, a pull-down menu is displayed, so that the desired answer ID in the corresponding project can be selected. In FIG. 31, the evaluation result is displayed in a graph format, but it is possible to switch to the display in a list format by clicking the “List” on the screen.

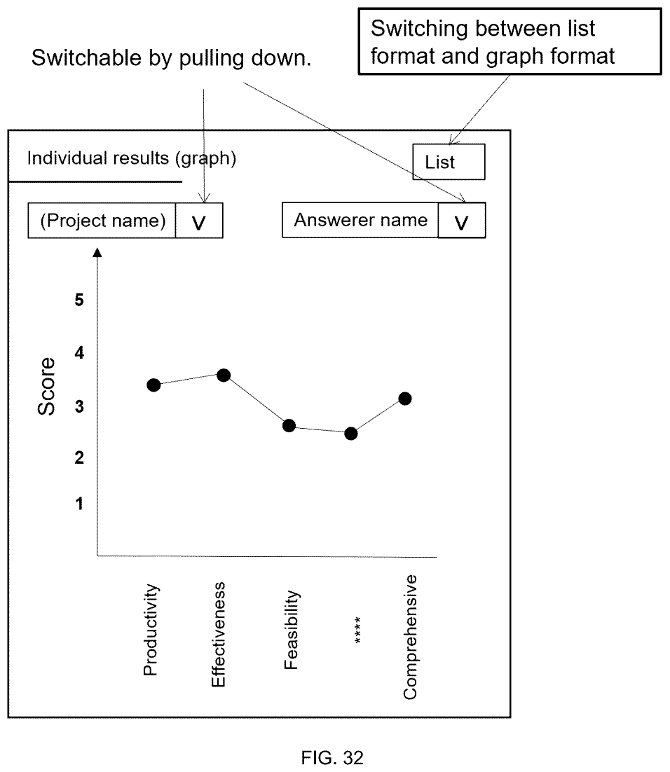

FIG. 32 shows an example of data related to the answerers displayed on the project administrator terminal 13. In FIG. 32, the score of a specific answerer for each evaluation axis for a specific project are shown in a graph format. By clicking “Project name” in FIG. 32, a pull-down menu is displayed, so that a desired project can be selected. Further, by clicking the “Answerer name”, a pull-down menu is displayed, so that the desired answerer in the corresponding project can be selected. In FIG. 32, the evaluation result is displayed in a graph format, but it is possible to switch to the display in a list format by clicking the “List” on the screen.

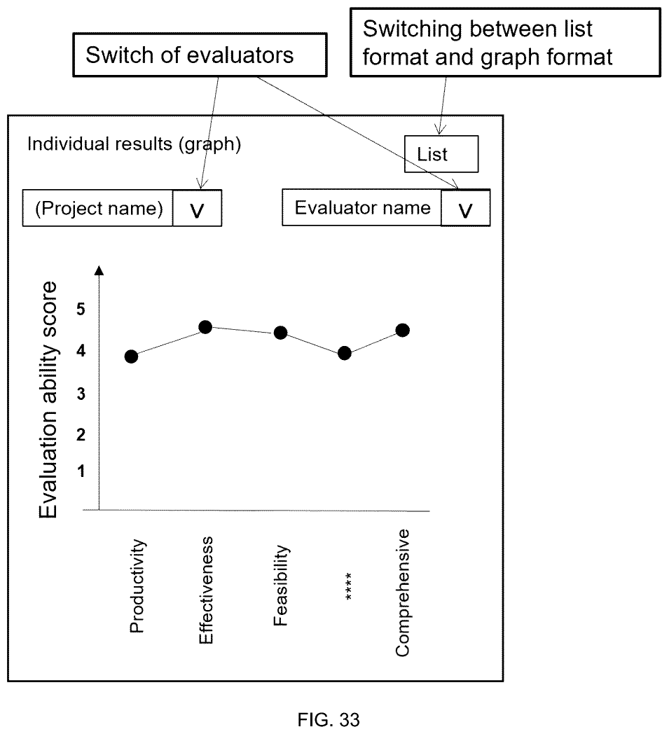

FIG. 33 shows an example of data related to the evaluators displayed on the project administrator terminal 13. In FIG. 33, the evaluation ability score of a specific evaluator for each evaluation axis for a specific project are shown in graph format. By clicking “Project name” in FIG. 33, a pull-down menu is displayed, so that a desired project can be selected. Further, by clicking the “Evaluator name”, a pull-down menu is displayed, so that the desired evaluator in the corresponding project can be selected. In FIG. 33, the evaluation result is displayed in a graph format, but it is possible to switch to the display in a list format by clicking the “List” on the screen.

[Participant (Evaluator, Answerer) Terminal]

The participant terminal 12 may also have the hardware configuration of the computer 200 described above. In the storage device 202 of the participant terminal 12, in addition to a program such as a web browser, browser data and data transmitted from/to the server 11 can be temporarily or non-transitory stored. The participant terminal 12 can input login information, input information as an evaluation target, input evaluation to the evaluation target, and the like by using the input device 204. The participant terminal 12 can display a login screen, a screen for inputting information as an evaluation target, a screen for inputting evaluation, evaluation analysis results (evaluator score data, answer score data, answerer score data and the like) and the like with the output device 203. The participant terminal 12 can communicate with the server 11 via the computer network 14 with the communication device 205. For example, it is possible to receive a login screen, information on an evaluation target, format data for inputting information as an evaluation target, format data for inputting evaluation, evaluation analysis data, and the like from the server 11, and is possible to transmit login information, answer data including the information as an evaluation target, evaluation result data, and the like to the server 11.

[Project Administrator Terminal]

The project administrator terminal 13 may also have the hardware configuration of the computer 200 described above. In the storage device 202 of the project administrator terminal 13, in addition to a program such as a web browser, browser data and data transmitted from/to the server 11 can be temporarily or non-transitory stored. The project administrator terminal 13 can input participant account information, input login information, input project implementation conditions, input session start instruction, and the like by using the input device 204. The project administrator terminal 13 can display participant account data, a login screen, a screen for inputting project implementation conditions, a screen for inputting evaluation target information, a screen for inputting evaluation, evaluation analysis results (evaluator score data, answer score data, answerer score data, and the like), and the like with the output device 203. The project administrator terminal 13 can communicate with the server 11 via the computer network 14 with the communication device 205. The project administrator terminal 13 is possible to receive, for example, a login screen, participant account data, answer data including the information as an evaluation target, evaluation result data, evaluation analysis data, evaluation progress data, and the like from the server 11, and is possible to transmit project implementation condition data (including evaluation start instruction), participant account data, login data, and the like to the server 11.

[Server Administrator Terminal]

The server administrator terminal 15 may also have the hardware configuration of the computer 200 described above. In the storage device 202 of the server administrator terminal 15, in addition to a program such as a web browser, browser data and data transmitted from/to the server 11 can be temporarily or non-transitory stored. The server administrator terminal 15 can input server administrator account data, input project administrator account data, input login information, and the like by using the input device 204. The server administrator terminal 15 can display server administrator account data, project administrator account data, a login screen, participant account data, a screen for inputting project implementation condition, a screen for inputting the information as an evaluation target, a screen for inputting evaluation, evaluation analysis results (evaluator score data, answer score data, answerer score data, and the like), and the like with the output device 203. The server administrator terminal 15 can communicate with the server 11 via the computer network 14 with the communication device 205. The server administrator terminal 15 is possible to receive, for example, a login screen, server administrator account data, project administrator account data, participant account data, answer data including the information as an evaluation target, evaluation result data input by the evaluator, evaluation analysis data, evaluation progress data, and the like from the server 11, and is possible to transmit server administrator account data, project administrator account data, login data, and the like to the server 11.

<2. Flow for Online Evaluation>

Next, a procedure of the method for online evaluation by the above-mentioned system will be described with reference to a flowchart for illustration.

(2-1 Setting Project Implementation Conditions)

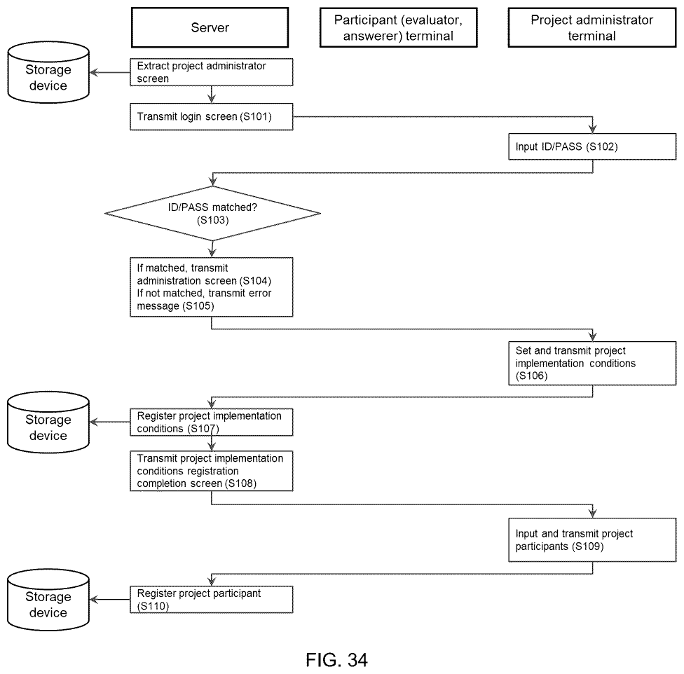

FIG. 34 is a flowchart showing a procedure in which a project administrator accesses the server, inputs the project implementation conditions, and registers the participants. When the project administrator accesses the server 11 by inputting a predetermined URL from the project administrator terminal 13, the server 11 transmits a login screen to the project administrator terminal 13 (S101). Next, when the project administrator inputs the organization ID and password into the project administrator terminal 13 and presses the login button (S102), the authentication processing part 321 of the server 11 determines whether or not the entered organization ID and password match the data stored in the project administrator account file 353 (S103), and if they match, an administration screen for the project administrator is transmitted to the project administrator terminal 13 (S104), and if they do not match, an error message is transmitted (S105).

If the login is successful, the administration screen is displayed on the project administrator terminal 13 (example: FIGS. 27 to 29). The project administrator inputs the project implementation conditions on the management screen and transmits them to the server 11 (S106). When the server 11 receives the data related to the project implementation conditions, the data registration part 325 stores the data in project data file 343, evaluation axis data file 344, question data file 345, answer column data file 346a, 346b, and the like, respectively.

When the registration of the project implementation conditions is completed, the server 11 transmits a screen for notifying the project implementation conditions to the project administrator terminal 13 (S108). The project administrator can confirm the registered information on the screen. Next, the project administrator inputs information about the participants (evaluators, answerers) who participate in the collection session and the evaluation session on the administration screen, and transmits the information to the server 11 (S109). When the server 11 receives the data including the information about the participants, the data registration part 325 stores the data in the participant account file 341, the session participant registration data file 342, and the like (S110).

(2-2 Collection Session)

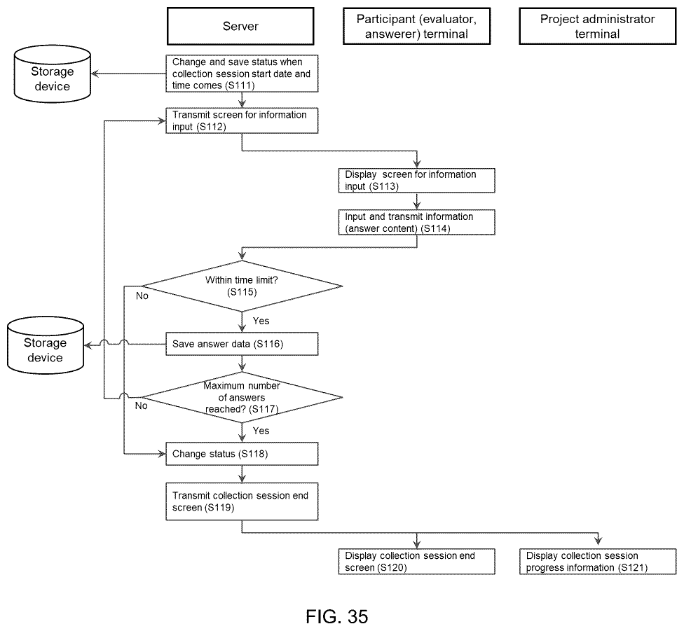

FIG. 35 shows a flow chart of the processing flow from the start to the end of a collection session. When it comes to a preset collection session start date and time, the server 11 automatically changes the status in the session participant registration data file 342 or the like to a status indicating that the collection session has started and stores the status (S111). The instruction to start the collection session may be transmitted to the server 11 by the project administrator clicking the “Start collection session” button on the administration screen of the project administrator terminal 13.

Next, the information input data extraction part 324 of the server 11 extracts question data including question texts related to a predetermined theme and specific question texts that describe the contents to be provided by the answerers and the like from the question data file 345 and the answer column data file (summarized) 346a, and extracts second format data that match the conditions stored in the answer column data files 346a and 346b from the second format data file 362, and transmits it to the answerer terminals 12 of a plurality of answerers who are flagged as answerers of the collection session in the session participant registration data file 342 (S112). In this way, the answerer terminal 12 displays a screen for inputting information (answer content) as shown in FIG. 23 (S113). In addition, although explanation in the flowchart is omitted, in order for the screen for inputting information to be displayed on the answerer terminal 12, the answerer terminal 12 also needs to be logged in after being authenticated by an authentication means such as an ID and password with the same procedure as the project administrator terminal 13.

After the information input screen is displayed on the answerer terminal 12, the answerer inputs the information (answer content) for the question on the screen and clicks the “Transmit” button. Accordingly, the answer data are transmitted from the answerer terminal 12 to the server 11 (S114). When the server 11 receives the answer data, the time limit judgement part 328 judges whether or not the answer data has been received within the time limit (S115). When it is judged that it is within the time limit, the data registration part 325 of the server 11 assigns an answer ID to the answer data, and stores the answer data in the answer data files 348a and 348b in association with the answerer ID and the like of the answerer who has transmitted the response data (S116).

Next, if a maximum number of answers is set, each time the answer number judgement part 330 of the server 11 receives one answer data from the answerer terminal 12, it increases the number of completed answers in the answer progress management file 356 corresponding to the answerer ID of the answerer by one, and judges whether or not this answerer has reached the maximum number of answers (S117). As a result, when it is judged that the maximum number of answers has not been reached, the information input data extraction part 324 transmits data including information necessary for answer input, such as unanswered question data, to the corresponding answerer terminal 12 (S112). In this way, the question data are repeatedly transmitted to the answerer terminal 12 until the maximum number of answers is reached.

Alternatively, in S112, the server 11 may collectively transmit question data including questions necessary for each answerer to input information (answer contents) to each answerer terminal 12. Further, the answerer terminal 12 may be able to collectively transmit the answer data to the server 11 in S114. In this case, the server 11 can receive all the answer data from the answerer at once, and it is not necessary to repeat S112.

On the other hand, when the answer data are received after the time limit has passed, or when it is judged that the time limit has passed regardless of whether or not the answer data has been received from the answerer terminal 12, or when the answer number judgement part 330 of the server 11 judges that the maximum number of answers has been reached, the time limit judgement part 328 of the server 11 records that the collection session has ended, and changes the status in the session participant registration data file 342 and the like to “Collection session ended” (S118). Further, it transmits a collection session end screen or a progress information that the collection session has ended to the answerer terminal 12 and the project administrator terminal 13 (S119). As a result, the answerer terminal 12 displays a screen indicating that the collection session has ended (S120), and the project administrator terminal 13 displays progress information indicating that the collection session has ended (S121).

(2-3 Evaluation Session)

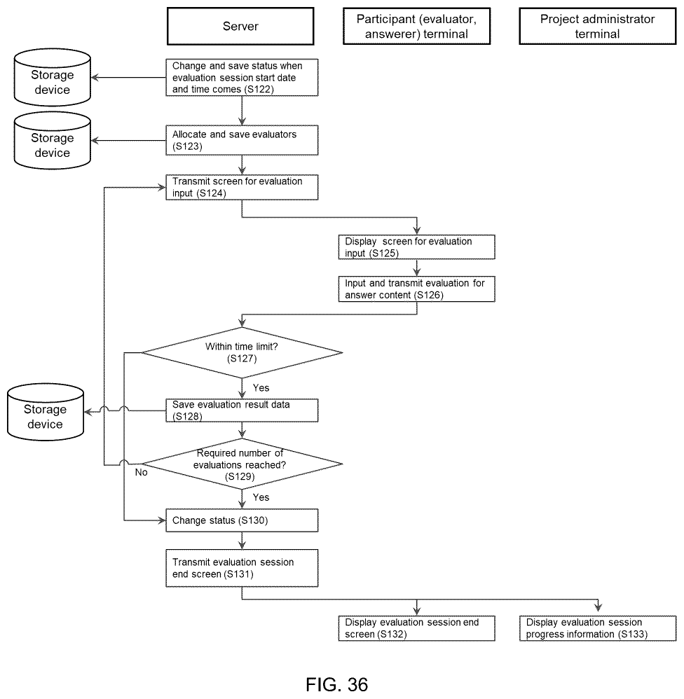

FIG. 36 shows a flow chart of a processing flow from the start to the end of an evaluation session. When it comes to a preset collection session start date and time, the server 11 automatically changes the status in the session participant registration data file 342 or the like to a status indicating that the evaluation session has started and stores the status (S111). The instruction to start the evaluation session may be transmitted to the server 11 by the project administrator clicking the “Start evaluation session” button on the administration screen of the project administrator terminal 13.

When the evaluator allocation part 322 of the server 11 receives the instruction to start the evaluation session, it allocates evaluators who should evaluate the information (answer content) in each of the answer data stored in the answer data file (detailed) 348b, from among a plurality of evaluators who have been flagged as evaluators for this evaluation session in the session participant registration data file 342. Then, for each evaluator, the evaluator allocation part 322 stores the evaluator ID, the answer ID to be evaluated, the required number of evaluations, and the like in association with each other in the evaluation progress management file 355 for managing the progress of each evaluation by the evaluator (S123).

In addition, the start of the allocation process by the evaluator allocation part 322 is not limited to the instruction for starting the evaluation session from the project administrator terminal 13, and may be started by any instruction for starting the evaluator allocation process. For example, the allocation process may be executed by receiving an instruction from the project administrator terminal 13 only for assigning an evaluator, and may be executed according to other instructions, or may be executed when the status is changed to end of the collection session.

The evaluation input data extraction part 323 of the server 11 extracts the answer data including the information (answer content) to be evaluated by each evaluator, based on the answer ID and the evaluator ID stored in the evaluation progress management file 355, and extracts the question data including the question texts related to the predetermined theme and the specific question texts describing the contents to be provided by the answerer, from the question data file 345 and the answer column data file (summarized) 346a, and extracts the first format data for evaluation input including a selective evaluation input section from the first format data file 361, based on the conditions related to evaluation axes stored in the evaluation axis data file 344, and transmit them to the corresponding evaluator terminal 12 (S124). As a result, the evaluator terminal 12 displays the evaluation input screen as shown in FIG. 22 (S125). In addition, although explanation in the flowchart is omitted, in order for the screen for inputting evaluation to be displayed on the evaluator terminal 12, the evaluator terminal 12 also needs to be logged in after being authenticated by an authentication means such as an ID and password with the same procedure as the project administrator terminal 13.

The evaluator clicks the button for evaluating the information (answer content) on the screen (example: “I do not agree very much”, “I can agree”, “I can agree very much”), and then click the “Transmit” button. Accordingly, the evaluation result data are transmitted from the evaluator terminal 12 to the server 11 (S126). When the server 11 receives the evaluation result data, the time limit judgement part 328 judges whether or not the evaluation result data has been received within the time limit (S127). When it is judged that it is within the time limit, the data registration part 325 of the server 11 assigns an evaluation ID to the evaluation result data, and stores the evaluation result data in the evaluation result data file 349 in association with the evaluator ID and the evaluation ID and the like of the evaluator who has transmitted the evaluation result data (S128).

Next, if a required number of evaluations is set, each time the answer number judgement part 330 of the server 11 receives one evaluation data from the evaluator terminal 12, it increases the number of completed evaluations in the evaluation progress management file 355 corresponding to the evaluator ID of the evaluator by one, and judges whether or not this evaluator has reached the required number of evaluations (S129). As a result, when it is judged that the required number of evaluations has not been reached, the evaluation input data extraction part 323 transmits data including information necessary for inputting evaluation, such as unevaluated answer data, together with the first format data in a displayable form from the transceiver 310 via the computer network 14 to the corresponding evaluator terminal 12 (S124). In this way, the answer data are repeatedly transmitted to the evaluator terminal 12 until the maximum number of evaluations is reached.

Alternatively, in S124, the server 11 may collectively transmit answer data including information (answer content) to be evaluated by each evaluator to each evaluator terminal 12. Further, the evaluator terminal 12 may be able to collectively transmit the evaluation result data to the server 11 in S126. In this case, the server 11 can receive all the evaluation result data from the evaluator at once, and it is not necessary to repeat S124.

On the other hand, when the evaluation result data are received after the time limit has passed, or when it is judged that the time limit has passed regardless of whether or not the evaluation result data has been received from the evaluator terminal 12, or when the evaluation number judgement part 329 of the server 11 judges that the required number of evaluations has been reached, the time limit judgement part 328 of the server 11 records that the evaluation session has ended, and changes the status in the session participant registration data file 342 and the like to “Evaluation session ended” (S130). Further, it transmits an evaluation session end screen or a progress information that the evaluation session has ended to the evaluator terminal 12 and the project administrator terminal 13 (S131). As a result, the evaluator terminal 12 displays a screen indicating that the evaluation session has ended (S132), and the project administrator terminal 13 displays progress information indicating that the evaluation session has ended (S133).

(2-4 Evaluation Analysis)

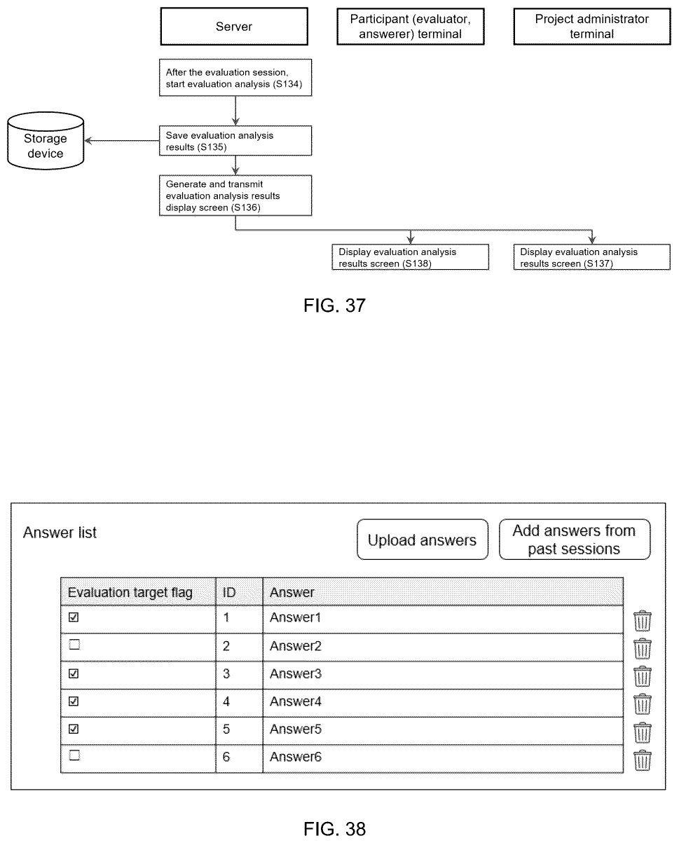

FIG. 37 is a flowchart showing a flow of processing in which the evaluation analysis part 326 of the server 11 performs evaluation analysis of the information (answer content) as an evaluation target, the answerers and the evaluators, and transmits the results to the participant terminal 12 and the project administrator terminal 13. When the evaluation session ends, the server 11 automatically starts the evaluation analysis (S134). The instruction to start the evaluation analysis may be transmitted to the server 11 by the project administrator clicking the “Start evaluation analysis” button on the management screen of the project administrator terminal 13.

The evaluation analysis part 326 of the server 11 generates, for example, the following evaluation analysis data based on the evaluation result data and the like stored in the evaluation result data file 349.
Degree of strictness of evaluator
Evaluation value corrected by analyzing the degree of strictness of evaluator
Temporary score, corrected score, and final score of evaluation target
Evaluation ability score of evaluator
Score of evaluation target (including rarity score)
Score of answerer

The evaluation analysis data are stored in the evaluation result data file 349, the evaluator score data file 350, the answer score data file 351 and the answerer score data file 352 according to the type of data (S135). The evaluation analysis data extraction part 327 of the server 11 extracts the evaluation analysis data and transmits them to the project administrator terminal 13 (S136). When the evaluation analysis data are received, a screen showing the evaluation analysis result is displayed on the screen of the project administrator terminal 13 (S137). The evaluation analysis results of all participants and all evaluation targets can be displayed on the project administrator terminal 13.

The evaluation analysis data may be transmitted to the participant terminals 12 in addition to the project administrator terminal 13. The evaluation analysis data to be transmitted to the participant terminals 12 can be set in advance by the administrator. For example, mention can be made to the score of the evaluation target provided by the participant himself/herself, the score of the evaluation target evaluated by the participant himself/herself, the answerer score of the participant himself/herself, the evaluation ability score of the participant himself/herself, and the like. Upon receiving the evaluation analysis data, the participant terminal 12 displays a preset screen showing the evaluation analysis result (S138).

### DESCRIPTION OF REFERENCE NUMERALS

11 Server
12 Participant (evaluator, answerer) terminal
13 Project administrator terminal
14 Computer network
15 Server administrator terminal
200 Computer
201 Processing device
202 Storage device
203 Output device
204 Input device
205 Communication device
206 Random number generator
207 Timer
310 Transceiver
320 Control unit
321 Authentication processing part
322 Evaluator allocation part
323 Evaluation input data extraction part
324 Information input data extraction part
325 Data registration part
326 Evaluation analysis part
327 Evaluation analysis data extraction part
328 Time limit judgement part
329 Evaluation number judgement part
330 Answer number judgement part
340 Storage unit
341 Participant account file
342 Session participant registration data file
343 Project data file
344 Evaluation axis data file
345 Question data file
346a Answer column data file (summarized)
346b Answer column data file (detailed)
348a Answer data file (summarized)
348b Answer data file (detailed)
349 Evaluation result data file
350 Evaluator score data file
351 Answer score data file
352 Answerer score data file
353 Project administrator account file
354 Server administrator account file
355 Evaluation progress management file
356 Answer progress management file
361 First format data file
362 Second format data file

What is claimed is:

1. A method for online evaluation, comprising:
a step 1A in which a server allocates evaluators who should evaluate a plurality of evaluation targets that are stored in an evaluation target data storage part and are assigned identifiers, from among a plurality of evaluators who are assigned identifiers as evaluators of a current evaluation session;
a step 1B in which the server extracts data related to the plurality of evaluation targets from the evaluation target data storage part according to a result of the step 1A, extracts question data related to a predetermined theme from a question data storage part, extracts first format data for evaluation input including a selective evaluation input section based on at least one evaluation axis from a first format data storage part, and transmits the data related to the plurality of evaluation targets, the question data, and the first format data to corresponding terminals of the plurality of evaluators via a network;
a step 1C in which the server receives evaluation result data including evaluations of the evaluation targets input by each evaluator in the selective evaluation input section, from the terminal of each evaluator via the network;
a step 1 D in which the server assigns an identifier to each of the evaluation result data that have been received, and stores the evaluation result data in an evaluation result data storage part in association with the identifier of each evaluator who has transmitted the evaluation result data and the identifier of each evaluation target;
a step 1E in which the server analyzes a degree of strictness of the evaluation by each evaluator for each evaluation axis based on the evaluation input in the selective evaluation input section by each evaluator in the evaluation result data stored in the evaluation result data storage part, and calculates a corrected evaluation by correcting the evaluation such that the evaluation by the evaluator who gives a strict evaluation rises relatively and the evaluation by the evaluator who gives a lax evaluation decreases relatively, and stores the corrected evaluation in the evaluation result data storage part in association with the identifier of each evaluator and the identifier of each evaluation target;
a step 1F in which the server aggregates the evaluations of each evaluation target based on the corrected evaluation and the identifier of the evaluation target stored in the evaluation result data storage part to calculate a provisional score of each evaluation target for each evaluation axis, and stores the provisional score in an evaluation target score data storage part in association with the identifier of each evaluation target;
a step 1G in which the server compares for each evaluation axis the corrected evaluation of each evaluation target associated with the identifier of the evaluator stored in the evaluation result data storage part with the provisional score of each evaluation target stored in the evaluation target score data storage part, aggregates closeness between them for each evaluator to calculate an evaluation ability score of each evaluator, and stores the evaluation ability score in an evaluator score data storage part in association with the identifier of each evaluator;
a step 1H in which the server aggregates the evaluations of each evaluation target based on the corrected evaluation, the identifier of the evaluators and the identifier of the evaluation target stored in the evaluation result data storage part, and the evaluation ability score of each evaluator stored in the evaluator score data storage part, to calculate a corrected score of each evaluation target for each evaluation axis on condition that a greater weighting is given to the evaluation by the evaluator with a higher evaluation ability score, and the server stores the corrected score in the evaluation target score data storage part in association with the identifier of each evaluation target; and
a step 1I in which the server extracts either or both of the following data (1) and (2), and transmits them to a terminal of an administrator via the network:
(1) data related to the evaluation targets, including the corrected score itself of each evaluation target for each evaluation axis and/or a statistic calculated based on the corrected score, stored in the evaluation target score data storage part.
(2) data related to the evaluators, including the evaluation ability score itself of each evaluator and/or a statistic calculated based on the evaluation ability score, stored in the evaluator score data storage part.

2. The method for online evaluation according to claim 1, wherein the corrected score of each evaluation target is regarded as the provisional score, and the server repeats the step 1G and the step 1 H one or more times.

3. The method for online evaluation according to claim 2, wherein the server stops repeating the step 1G any more when either or both of the following conditions (a) and (b) are satisfied:
(a) each time the step 1G is repeated, the server calculates a difference or rate of change for each evaluation axis between a latest evaluation ability score and a previous evaluation ability score of each evaluator, and when the server judges whether or not the difference or rate of change satisfies a preset condition for each evaluator, the preset condition is satisfied for all the evaluators;
(b) each time the step 1 H is repeated, the server calculates a difference or rate of change for each evaluation axis between a latest corrected score and a previous corrected score of each evaluation target, and when the server judges whether or not the difference or rate of change satisfies a preset condition for each evaluation target, the preset condition is satisfied for all the evaluation targets.

4. A method for online evaluation, comprising:
a step 1A in which a server allocates evaluators who should evaluate a plurality of evaluation targets that are stored in an evaluation target data storage part and are assigned identifiers, from among a plurality of evaluators who are assigned identifiers as evaluators for a current evaluation session;
a step 1B in which the server extracts data related to the plurality of evaluation targets from the evaluation target data storage part according to a result of the step 1A, extracts question data related to a predetermined theme from a question data storage part, and extracts first format data for evaluation input including a selective evaluation input section based on at least one evaluation axis from a first format data storage part, and transmits the data related to the plurality of evaluation targets, the question data, and the first format data to corresponding terminals of the plurality of evaluators via a network;
a step 1C in which the server receives evaluation result data including evaluations of the evaluation targets input by each evaluator in the selective evaluation input section, from the terminal of each evaluator via the network;
a step 1 D in which the server assigns an identifier to each of the evaluation result data that have been received, and stores the evaluation result data in an evaluation result data storage part in association with the identifier of each evaluator who has transmitted the evaluation result data and the identifier of each evaluation target;
a step 1E in which the server analyzes a degree of strictness of the evaluation by each evaluator for each evaluation axis based on the evaluation input in the selective evaluation input section by each evaluator in the evaluation result data stored in the evaluation result data storage part, and calculates a corrected evaluation by correcting the evaluation such that the evaluation by the evaluator who gives a strict evaluation rises relatively and the evaluation by the evaluator who gives a lax evaluation decreases relatively, and stores the corrected evaluation in the evaluation result data storage part in association with the identifier of each evaluator and the identifier of each evaluation target;
a step 1F in which, the server performs for each of the first to n^{th} evaluator, assuming that a number of the evaluators is n (n is an integer of 2 or more), without considering the evaluation of the evaluation target by the k^{th} evaluator (k is an integer from 1 to n), aggregating the evaluations of each evaluation target based on the corrected evaluation by the evaluators other than the k^{th} evaluator and the identifier of the evaluation target stored in the evaluation result data storage part to calculate a provisional score of each evaluation target for each evaluation axis, and storing the provisional score in an evaluation target score data storage part in association with the identifier of the k^{th} evaluator and the identifier of each evaluation target;
a step 1G₁ in which the server performs for each of the first to n^{th} evaluator comparing for each evaluation axis the corrected evaluation of each evaluation target associated with the identifier of the k^{th} (k is an integer from 1 to n) evaluator stored in the evaluation result data storage part with the provisional score of each evaluation target stored in the evaluation target score data storage part associated with the identifier of the k^{th} evaluator and the identifier of each evaluation target, aggregating closeness between them for each evaluator to calculate a provisional evaluation ability score of the k^{th} evaluator, and storing the provisional evaluation ability score in the evaluator score data storage part in association with the identifier of the k^{th} evaluator;
a step 1H₁ in which the server performs for each of the first to n^{th} evaluator, without considering the evaluation of the evaluation target by the k^{th} evaluator (k is an integer from 1 to n), aggregating the evaluations of each evaluation target based on the corrected evaluation by the evaluators other than the k^{th} evaluator, the identifier of the evaluators and the identifier of the evaluation target stored in the evaluation result data storage part, and the provisional evaluation ability score of the evaluators other than the k^{th} evaluator stored in the evaluator score data storage part to calculate a corrected score of each evaluation target for each evaluation axis, on condition that a greater weighting is given to the evaluation by the evaluator with a higher provisional evaluation ability score, and storing the corrected score in the evaluation target score data storage part in association with the identifier of the k^{th} evaluator and the identifier of each evaluation target;
a step 1G₂ in which the server performs for each of the first to n^{th} evaluator comparing for each evaluation axis the corrected evaluation of each evaluation target associated with the identifier of the k^{th} (k is an integer from 1 to n) evaluator stored in the evaluation result data storage part with the corrected score of each evaluation target stored in the evaluation target score data storage part associated with the identifier of the k^{th} evaluator and the identifier of each evaluation target, aggregating closeness between them for each evaluator to calculate a final evaluation ability score of the k^{th} evaluator, and storing the final evaluation ability score in the evaluator score data storage part in association with the identifier of the k^{th} evaluator;
a step 1 H₂ in which the server aggregates the evaluations of each evaluation target based on the corrected evaluation, the identifier of the evaluators and the identifier of the evaluation target stored in the evaluation result data storage part, and the final evaluation ability score of each evaluator stored in the evaluator score data storage part, to calculate a final score of each evaluation target for each evaluation axis, on condition that a greater weighting is given to the evaluation by the evaluator with a higher final evaluation ability score, and the server stores the final score in the evaluation target score data storage part in association with the identifier of each evaluation target; and
a step 1I in which the server extracts either or both of the following data (1) and (2) and transmits them to a terminal of an administrator via the network:
(1) data related to the evaluation targets, including the final score itself of each evaluation target for each evaluation axis and/or a statistic calculated based on the final score, stored in the evaluation target score data storage part.
(2) data related to the evaluators, including the final evaluation ability score itself of each evaluator and/or a statistic calculated based on the final evaluation ability score, stored in the evaluator score data storage part.

5. The method for online evaluation according to claim 4, wherein the corrected score of each evaluation target is regarded as the provisional score, and the server repeats the step 1G₁ and the step 1H₁ one or more times.

6. The method for online evaluation according to claim 5, wherein the server stops repeating the step 1G₁ any more when either or both of the following conditions (a) and (b) are satisfied:
(a) each time the step 1G₁ is repeated, the server calculates a difference or rate of change for each evaluation axis between a latest provisional evaluation ability score and a previous provisional evaluation ability score of each evaluator, and when the server judges whether or not the difference or rate of change satisfies a preset condition for each evaluator, the preset condition is satisfied for all the evaluators;
(b) each time the step 1H₁ is repeated, the server calculates a difference or rate of change for each evaluation axis between a latest corrected score and a previous corrected score of each evaluation target, and when the server judges whether or not the difference or rate of change satisfies a preset condition for each evaluation target, the preset condition is satisfied for all the evaluation targets.

7. The method for online evaluation according to claim 1, wherein the evaluation target data storage part may also store data related to a plurality of different evaluation targets from the plurality of evaluation targets used in the current evaluation session, and the method further comprises:
a step 1J in which the server calculates similarity between each of the plurality of evaluation targets in the current evaluation session and the other evaluation targets used in the current evaluation session and/or the different evaluation targets, aggregates the similarity to calculate a rarity score of each evaluation target in the current evaluation session, and stores the rarity score in the evaluation target score data storage part in association with the identifier each evaluation target; and
a step 1K in which the server transmits data related to the evaluation targets, including the rarity score itself of each evaluation target and/or a statistic calculated based on the rarity score, stored in the evaluation target score data storage part, to the terminal of the administrator via the network.

8. The method for online evaluation according to claim 1, further comprising:
a step 2A in which the server extracts the question data related to the predetermined theme from the question data storage part, extracts second format data including at least one information input section from a second format data storage part, and transmits the question data and the second format data via the network to terminals of a plurality of answerers who are assigned identifiers as answerers of a collection session;
a step 2B in which the server receives answer data including information about the theme input by each answerer of the collection session in the information input section from the terminal of each answerer of the collection session; and
a step 2C in which the server assigns an identifier to each of the answerer data that have been received including the information about the theme, and stores the answer data including the information about the theme in the evaluation target data storage part in association with the identifier of each answerer in the collection session who has transmitted the answer data including the information about the theme;
wherein the answer data including the information about the theme is used as the data related to the evaluation targets.

9. The method for online evaluation according to claim 8, further comprising:
a step 2D in which the server calculates a score of the answerer for at least one evaluation axis, based on data related to the evaluation targets including the corrected score or the final score itself of each evaluation target for each evaluation axis and/or a statistic calculated based on the corrected score or the final score, and the identifier of the answerer stored in the evaluation target score data storage part, and the server stores the score of the answerer in a answerer score data storage part; and
a step 2E in which the server transmits data related to the answerers, including the score itself of each answerer for each evaluation axis and/or a statistic calculated based on the score stored in the answerer score data storage part, to the terminal of the administrator via the network.

10. The method for online evaluation according to claim 1, wherein the evaluation targets are ideas related to the predetermined theme.

11. The method for online evaluation according to claim 1, wherein the data related to the evaluation targets include text information.

12. A server for online evaluation, comprising a transceiver, a control unit, and a storage unit, wherein
the storage unit comprises:
an evaluation target data storage part for storing data related to a plurality of evaluation targets,
a first format data storage part for storing first format data for evaluation input including a selective evaluation input section based on at least one evaluation axis;
an evaluation result data storage part for storing evaluation result data including an evaluation and a corrected evaluation of each evaluation target;
an evaluation target score data storage part for storing a provisional score and a corrected score of each evaluation target for each evaluation axis;
an evaluator score data storage part for storing an evaluation ability score of each evaluator;
the control unit comprises an evaluator allocation part, an evaluation input data extraction part, a data registration part, an evaluation analysis part, and an evaluation analysis data extraction part, wherein
the evaluator allocation part is capable of performing a step 1A comprising allocating evaluators who should evaluate the plurality of evaluation targets that are stored in the evaluation target data storage part and are assigned identifiers, from among a plurality of evaluators who are assigned identifiers as evaluators of a current evaluation session,
the evaluation input data extraction part is capable of performing a step 1B comprising extracting the data related to the plurality of evaluation targets from the evaluation target data storage part according to a result of the step 1A, extracting question data related to a predetermined theme from a question data storage part, extracting the first format data from the first format data storage part, and transmitting the data related to the plurality of evaluation targets, the question data, and the first format data to corresponding terminals of the plurality of evaluators via a network;
the transceiver is capable of performing a step 1C comprising receiving the evaluation result data including evaluations of the evaluation targets input by each evaluator in the selective evaluation input section, from the terminal of each evaluator via the network, wherein
the data registration part is capable of performing a step 1D comprising assigning an identifier to each of the evaluation result data that have been received, and storing the evaluation result data in the evaluation result data storage part in association with the identifier of each evaluator who has transmitted the evaluation result data and the identifier of each evaluation target;
the evaluation analysis part is:
capable of performing a step 1 E comprising analyzing a degree of strictness of the evaluation of each evaluator for each evaluation axis based on the evaluation input in the selective evaluation input section by each evaluator in the evaluation result data stored in the evaluation result data storage part, and calculating a corrected evaluation by correcting the evaluation such that the evaluation by the evaluator who gives a strict evaluation rises relatively and the evaluation by the evaluator who gives a lax evaluation decreases relatively, and storing the corrected evaluation in the evaluation result data storage part in association with the identifier of each evaluator and the identifier of each evaluation target;
capable of performing a step 1F comprising aggregating the evaluations of each evaluation target based on the corrected evaluation and the identifier of the evaluation target stored in the evaluation result data storage part to calculate the provisional score of each evaluation target for each evaluation axis, and storing the provisional score in the evaluation target score data storage part in association with the identifier of each evaluation target;
capable of performing a step 1G comprising comparing for each evaluation axis the corrected evaluation of each evaluation target associated with the identifier of the evaluator stored in the evaluation result data storage part with the provisional score of each evaluation target stored in the evaluation target score data storage part, aggregating closeness between them for each evaluator to calculate the evaluation ability score of each evaluator, and storing the evaluation ability score in the evaluator score data storage part in association with the identifier of each evaluator;
capable of performing a step 1H comprising aggregating the evaluations for each evaluation target based on the corrected evaluation, the identifier of the evaluators and the identifier of the evaluation target stored in the evaluation result data storage part, and the evaluation ability score of each evaluator stored in the evaluator score data storage part, to calculate the corrected score of each evaluation target for each evaluation axis, on condition that a greater weighting is given to the evaluation by the evaluator with a higher evaluation ability score, and storing the corrected score in the evaluation target score data storage part in association with the identifier of each evaluation target; and
the evaluation analysis data extraction part is capable of perform a step 1I comprising extracting either or both of the following data (1) and (2), and transmitting them from the transceiver to a terminal of an administrator via the network:
(1) data related to the evaluation targets, including the corrected score itself of each evaluation target for each evaluation axis and/or a statistic calculated based on the corrected score, stored in the evaluation target score data storage part.
(2) data related to the evaluators, including the evaluation ability score itself of each evaluator and/or a statistic calculated based on the evaluation ability score, stored in the evaluator score data storage part.

13. The server for online evaluation according to claim 12, wherein the corrected score of each evaluation target is regarded as the provisional score, and the evaluation analysis part is capable of repeating the step 1G and the step 1H one or more times.

14. The server for online evaluation according to claim 13, wherein the evaluation analysis part stops repeating the step 1G any more when either or both of the following conditions (a) and (b) are satisfied:
(a) each time the step 1G is repeated, the evaluation analysis part calculates a difference or rate of change for each evaluation axis between a latest evaluation ability score and a previous evaluation ability score of each evaluator, and when the evaluation analysis part judges whether or not the difference or rate of change satisfies a preset condition for each evaluator, the preset condition is satisfied for all the evaluators;
(b) each time the step 1 H is repeated, the evaluation analysis part calculates a difference or rate of change for each evaluation axis between a latest corrected score and a previous corrected score of each evaluation target, and when the evaluation analysis part judges whether or not the difference or rate of change satisfies a preset condition for each evaluation target, the preset condition is satisfied for all the evaluation targets.

15. A server for online evaluation, comprising a transceiver, a control unit, and a storage unit, wherein
the storage unit comprises:
an evaluation target data storage part for storing data related to a plurality of evaluation targets,
a first format data storage part for storing first format data for evaluation input including a selective evaluation input section based on at least one evaluation axis;
an evaluation result data storage part for storing evaluation result data including an evaluation and a corrected evaluation of each evaluation target;
an evaluation target score data storage part for storing a provisional score, a corrected score, and a final score of each evaluation target for each evaluation axis;
an evaluator score data storage part for storing a provisional evaluation ability score and a final evaluation ability score of each evaluator;
the control unit comprises an evaluator allocation part, an evaluation input data extraction part, a data registration part, an evaluation analysis part, and an evaluation analysis data extraction part, wherein
the evaluator allocation part is capable of performing a step 1A comprising allocating evaluators who should evaluate the plurality of evaluation targets that are stored in the evaluation target data storage part and assigned identifiers, from among a plurality of evaluators who are assigned identifiers as evaluators of a current evaluation session,
the evaluation input data extraction part is capable of performing a step 1B comprising extracting the data related to the plurality of evaluation targets from the evaluation target data storage part according to a result of the step 1A, extracting question data related to a predetermined theme from a question data storage part, extracting the first format data from the first format data storage part, and transmitting the data related to the plurality of evaluation targets, the question data, and the first format data to corresponding terminals of the plurality of evaluators via a network;
the transceiver is capable of performing a step 1C comprising receiving the evaluation result data including the evaluations of the evaluation targets input by each evaluator in the selective evaluation input section, from the terminal of each evaluator via the network, wherein
the data registration part is capable of performing a step 1D comprising assigning an identifier to each of the evaluation result data that have been received, and storing the evaluation result data in the evaluation result data storage part in association with the identifier of each evaluator who has transmitted the evaluation result data and the identifier of each evaluation target;
the evaluation analysis part is:
capable of performing a step 1 E comprising analyzing a degree of strictness of the evaluation of each evaluator for each evaluation axis based on the evaluation input in the selective evaluation input section by each evaluator in the evaluation result data stored in the evaluation result data storage part, and calculating a corrected evaluation by correcting the evaluation such that the evaluation by the evaluator who gives a strict evaluation rises relatively and the evaluation by the evaluator who gives a lax evaluation decreases relatively, and storing the corrected evaluation in the evaluation result data storage part in association with the identifier of each evaluator and the identifier of each evaluation target;
capable of performing a step 1F comprising, for each of the first to n^{th} evaluator, assuming that a number of the evaluators is n (n is an integer of 2 or more), without considering the evaluation of the evaluation target by the k^{th} evaluator (k is an integer from 1 to n), aggregating the evaluations of each evaluation target based on the corrected evaluation by the evaluators other than the k^{th} evaluator and the identifier of the evaluation target stored in the evaluation result data storage part to calculate a provisional score of each evaluation target for each evaluation axis, and storing the provisional score in the evaluation target score data storage part in association with the identifier of the k^{th} evaluator and the identifier of each evaluation target;
capable of performing a step 1G₁ comprising, for each of the first to n^{th} evaluator, comparing for each evaluation axis the corrected evaluation of each evaluation target associated with the identifier of the k^{th} (k is an integer from 1 to n) evaluator stored in the evaluation result data storage part with the provisional score of each evaluation target stored in the evaluation target score data storage part associated with the identifier of the k^{th} evaluator and the identifier of each evaluation target, aggregating closeness between them for each evaluator to calculate the provisional evaluation ability score of the k^{th} evaluator, and storing the provisional evaluation ability score in the evaluator score data storage part in association with the identifier of the k^{th} evaluator;
capable of performing a step 1H₁ comprising, for each of the first to n^{th} evaluator, without considering the evaluation of the evaluation target by the k^{th} evaluator (k is an integer from 1 to n), aggregating the evaluations of each evaluation target based on the corrected evaluation by the evaluators other than the k^{th} evaluator, the identifier of the evaluators and the identifier of the evaluation target stored in the evaluation result data storage part, and the provisional evaluation ability score of the evaluators other than the k^{th} evaluator stored in the evaluator score data storage part to calculate a corrected score of each evaluation target for each evaluation axis, on condition that a greater weighting is given to the evaluation by the evaluator with a higher provisional evaluation ability score, and storing the corrected score in the evaluation target score data storage part in association with the identifier of the k^{th} evaluator and the identifier of each evaluation target;
capable of performing a step 1G₂ comprising, for each of the first to n^{th} evaluator, comparing for each evaluation axis the corrected evaluation of each evaluation target associated with the identifier of the k^{th} (k is an integer from 1 to n) evaluator stored in the evaluation result data storage part with the corrected score of each evaluation target stored in the evaluation target score data storage part associated with the identifier of the k^{th} evaluator and the identifier of each evaluation target, aggregating closeness between them for each evaluator to calculate a final evaluation ability score of the k^{th} evaluator, and storing the final evaluation ability score in the evaluator score data storage part in association with the identifier of the k^{th} evaluator;
capable of performing a step 1H₂ comprising aggregating the evaluations of each evaluation target based on the corrected evaluation, the identifier of the evaluator and the identifier of the evaluation target stored in the evaluation result data storage part, and the final evaluation ability score of each evaluator stored in the evaluator score data storage part, to calculate the final score of each evaluation target for each evaluation axis, on condition that a greater weighting is given to the evaluation by the evaluator with a higher final evaluation ability score, and storing the final score in the evaluation target score data storage part in association with the identifier of each evaluation target; and
the evaluation analysis data extraction part is capable of performing a step 1I comprising extracting either or both of the following data (1) and (2) and transmitting them from the transceiver to a terminal of an administrator via the network:
(1) data related to the evaluation targets, including the final score itself of each evaluation target for each evaluation axis and/or a statistic calculated based on the final score, stored in the evaluation target score data storage part.
(2) data related to the evaluators, including the final evaluation ability score itself of each evaluator and/or a statistic calculated based on the final evaluation ability score, stored in the evaluator score data storage part.

16. The server for online evaluation according to claim 15, wherein the evaluation analysis part regards the corrected score of each evaluation target as the provisional score, and repeats the step 1G₁ and the step 1H₁ one or more times.

17. The server for online evaluation according to claim 16, wherein the evaluation analysis part stops repeating the step 1G₁ any more when either or both of the following conditions (a) and (b) are satisfied:
(a) each time the step 1G₁ is repeated, the evaluation analysis part calculates a difference or rate of change for each evaluation axis between a latest provisional evaluation ability score and a previous provisional evaluation ability score of each evaluator, and when the evaluation analysis part judges whether or not the difference or rate of change satisfies a preset condition for each evaluator, the preset condition is satisfied for all the evaluators;
(b) each time the step 1H₁ is repeated, the evaluation analysis part calculates a difference or rate of change for each evaluation axis between a latest corrected score and a previous corrected score of each evaluation target, and when the evaluation analysis part judges whether or not the difference or rate of change satisfies a preset condition for each evaluation target, the preset condition is satisfied for all the evaluation targets.

18. The server for online evaluation according to claim 12, wherein the evaluation target data storage part may also store data related to a plurality of different evaluation targets from the plurality of evaluation targets used in the current evaluation session,
the evaluation analysis part is capable of performing a step 1J comprising calculating similarity between each of the plurality of evaluation targets in the current evaluation session and the other evaluation targets used in the current evaluation session and/or the different evaluation targets, aggregating the similarity to calculate a rarity score of each evaluation target in the current evaluation session, and storing the rarity score in the evaluation target score data storage part in association with the identifier each evaluation target; and
the evaluation analysis data extraction part is capable of performing a step 1K comprising extracting data related to the evaluation targets, including the rarity score itself of each evaluation target and/or a statistic calculated based on the rarity score stored in the evaluation target score data storage part, and transmitting them from the transceiver to the terminal of the administrator via the network.

19. The server for online evaluation according to claim 12, wherein
the storage unit comprises a question data storage part for storing question data related to the predetermined theme, and a second format data storage part for storing second format data including at least one information input section;
the control unit comprises an information input data extraction part;
the information input data extraction part is capable of performing a step 2A comprising extracting the question data related to the predetermined theme from the question data storage part, extracting the second format data from the second format data storage part, and transmitting the question data and the second format data from the transceiver via the network to terminals of a plurality of answerers who are assigned identifiers as answerers of a collection session;
the transceiver is capable of performing a step 2B comprising receiving answer data including information about the theme input by each answerer of the collection session in the information input section from the terminal of each answerer of the collection session; and
the data registration part is capable of performing a step 2C comprising assigning an identifier to each of the answer data that have been received including the information about the theme, and storing the answer data including the information about the theme in the evaluation target data storage part in association with the identifier of each answerer in the collection session who has transmitted the answer data including the information about the theme.

20. The server for online evaluation according to claim 19, wherein
the storage unit comprises an answerer score data storage part for storing scores for each evaluation axis of the answerers;
the evaluation analysis part is capable of performing a step 2D comprising calculating a score of the answerer for at least one evaluation axis, based on data related to the evaluation targets including the corrected score or the final score itself of each evaluation target for each evaluation axis and/or a statistic calculated based on the corrected score or the final score, and the identifier of the answerer stored in the evaluation target score data storage part, and storing the score of the answerer in the answerer score data storage part; and
the evaluation analysis data extraction part is capable of performing a step 2E comprising transmitting data related to the answerers, including the score itself of each answerer for each evaluation axis and/or a statistic calculated based on the score stored in the answerer score data storage part, from the transceiver to the terminal of the administrator via the network.

21. The server for online evaluation according to claim 12, wherein the evaluation targets are ideas related to the predetermined theme.

22. The server for online evaluation according to claim 12, wherein the data related to the evaluation targets include text information.
